(19) United States
(12) Patent Application Publication
(10) Pub. No.: US 2026/0019676 A1
(43) Pub. Date: Jan. 15, 2026

(54) CONTENT PUSHING METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventors: Pengyu CHEN, Shenzhen (CN); Zhengjun LIU, Shenzhen (CN)

(73) Assignee: TENCENT TECHNOLOGY (SHENZHEN) COMPANY LIMITED, Shenzhen (CN)

(21) Appl. No.: 19/335,061

(22) Filed: Sep. 22, 2025

Related U.S. Application Data
(63) Continuation of application No. PCT/CN2024/100878, filed on Jun. 24, 2024.

(30) Foreign Application Priority Data
Sep. 8, 2023 (CN) 202311156418.7

(51) Int. Cl. H04N 21/466; G06V 10/80; H04N 21/44

(52) U.S. Cl. CPC H04N 21/4668; G06V 10/806; H04N 21/44008

(57) ABSTRACT

A content pushing method, apparatus, and computer-readable storage medium for personalized content recommendation based on viewing sequence analysis. The method obtains a user's current information sequence containing information items arranged in viewing order, including current and historical viewed content. The sequence is encoded into feature sequences with corresponding feature items. Description information of current viewed content is encoded to obtain its encoded feature. Related features are extracted from the feature sequence based on the current viewed content's encoded feature. Description information of candidate content is encoded to obtain encoded features for each candidate. A candidate content is selected based on comparison between candidate encoded features and the related feature of current viewed content, then pushed to the user for personalized recommendations.

### CROSS-REFERENCE TO RELATED APPLICATIONS

This application is a continuation application of International Application No. PCT/CN2024/100878 filed on Jun. 24, 2024 which claims priority to Chinese Patent Application No. 202311156418.7, filed with the China National Intellectual Property Administration on Sep. 8, 2023, the disclosures of each being incorporated by reference herein in their entireties.

### FIELD

The disclosure relates to the field of computer technologies, a content pushing method and apparatus, a computer device, a storage medium, and a computer program product.

### BACKGROUND

With the development of artificial intelligence and computer technologies, a content pushing technology based on artificial intelligence emerges. The content pushing technology based on artificial intelligence is used for pushing a content in a content platform by means of artificial intelligence. The content platform may include, but is not limited to, a video platform, an audio platform, or a news platform. The video platform is used as an example. The video platform may push a related content of a video in the video platform to a user.

In the related art, features of a user and a content historically viewed by the user may be used as reference information, and a content pushed to the user is determined by analyzing the reference information through artificial intelligence.

However, the content pushed may not necessarily align with real-time needs of the user, resulting in low pushing accuracy. Consequently, many resources may be consumed to achieve a pushing target.

### SUMMARY

Provided are a content pushing method and apparatus, a device, a storage medium, and a program product, which can implement personalized content recommendation through sequence-based feature encoding and related feature extraction from user viewing history.

According to some embodiments, a content pushing method, performed by a computer device, includes: obtaining a current information sequence of a user comprising a plurality of information items that are arranged in a viewing order, the plurality of information items comprising at least one information item corresponding to at least one current viewed content and at least one information item corresponding to at least one historical viewed content; encoding the current information sequence into a feature sequence, the feature sequence comprising feature items corresponding with the information items, each of the feature items representing an encoded feature; obtaining and encoding description information of the at least one current viewed content to obtain an encoded feature of the at least one current viewed content; extracting, from the feature sequence, a feature related to the encoded feature of the current viewed content, to obtain a related feature of the current viewed content; obtaining and encoding description information of at least one candidate content to obtain an encoded feature of each of the at least one candidate content; selecting a candidate content from the at least one candidate content based on the encoded feature of each of the at least one candidate content and the related feature of the current viewed content; and pushing the selected candidate content to the user.

According to some embodiments, a content pushing apparatus, includes: at least one memory configured to store program code; and at least one processor configured to read the program code and operate as instructed by the program code, the program code including: obtaining code configured to cause at least one of the at least one processor to obtain a current information sequence of a user comprising a plurality of information items that are arranged in a viewing order, the plurality of information items comprising at least one information item corresponding to at least one current viewed content and at least one information item corresponding to at least one historical viewed content; encoding code configured to cause at least one of the at least one processor to encode the current information sequence into a feature sequence, the feature sequence comprising feature items corresponding with the information items, each of the feature items representing an encoded feature; description code configured to cause at least one of the at least one processor to obtain and encode description information of the at least one current viewed content to obtain an encoded feature of the at least one current viewed content; extracting code configured to cause at least one of the at least one processor to extract, from the feature sequence, a feature related to the encoded feature of the current viewed content, to obtain a related feature of the current viewed content; candidate code configured to cause at least one of the at least one processor to obtain and encode description information of at least one candidate content to obtain an encoded feature of each of the at least one candidate content; selecting code configured to cause at least one of the at least one processor to select a candidate content from the at least one candidate content based on the encoded feature of each of the at least one candidate content and the related feature of the current viewed content; and pushing code configured to cause at least one of the at least one processor to push the selected candidate content to the user.

According to some embodiments, a non-transitory computer-readable storage medium, storing computer code which, when executed by at least one processor, causes the at least one processor to at least: obtain a current information sequence of a user comprising a plurality of information items that are arranged in a viewing order, the plurality of information items comprising at least one information item corresponding to at least one current viewed content and at least one information item corresponding to at least one historical viewed content; encode the current information sequence into a feature sequence, the feature sequence comprising feature items corresponding with the information items, each of the feature items representing an encoded feature; obtain and encode description information of the at least one current viewed content to obtain an encoded feature of the at least one current viewed content; extract, from the feature sequence, a feature related to the encoded feature of the current viewed content, to obtain a related feature of the current viewed content; obtain and encode description information of at least one candidate content to obtain an encoded feature of each of the at least one candidate content; select a candidate content from the at least one candidate content based on the encoded feature of each of the at least one candidate content and the related feature of the current viewed content; and push the selected candidate content to the user.

### BRIEF DESCRIPTION OF THE DRAWINGS

To describe technical solutions of embodiments of this application or related technologies more clearly, the following briefly introduces the accompanying drawings required for describing embodiments or related technologies. Clearly, the accompanying drawings in the following descriptions show only some embodiments of this application, and a person of ordinary skill in the art may still derive other drawings based on these accompanying drawings without creative efforts.

FIG. 1 is a diagram of an application environment of a content pushing method according to some embodiments.

FIG. 2 is a flowchart of a content pushing method according to some embodiments.

FIG. 3 is a diagram of an interface in which a terminal displays a current viewed content and push information according to some embodiments.

FIG. 4 is a diagram of a structure of a related feature generation network for a current viewed content according to some embodiments.

FIG. 5 is a diagram of a structure of a feature extraction network according to some embodiments.

FIG. 6 is a diagram of a structure of a correlation feature generation network according to some embodiments.

FIG. 7 is a diagram illustrating a principle of generating a content fusion feature according to some embodiments.

FIG. 8 is a diagram of a structure of an identifier feature extraction network according to some embodiments.

FIG. 9 is a diagram of a structure of a recommendation score prediction network according to some embodiments.

FIG. 10 is a diagram of a structure of a recommendation score prediction model according to some embodiments.

FIG. 11 is a diagram illustrating a principle of training a recommendation score prediction model according to some embodiments.

FIG. 12 is a flowchart of a content pushing method according to another embodiment.

FIG. 13 is a block diagram of a structure of a content pushing apparatus according to some embodiments.

FIG. 14 is a diagram of an internal structure of a computer device according to some embodiments.

FIG. 15 is a diagram of an internal structure of a computer device according to some embodiments.

### DESCRIPTION OF EMBODIMENTS

Technical solutions in embodiments of this application are clearly and completely described in the following with reference to accompanying drawings in the embodiments of this application. Clearly, the described embodiments are merely a part rather than all of the embodiments of this application. All other embodiments obtained by a person of ordinary skill in the art based on the embodiments of this application without creative efforts shall fall within the protection scope of this application.

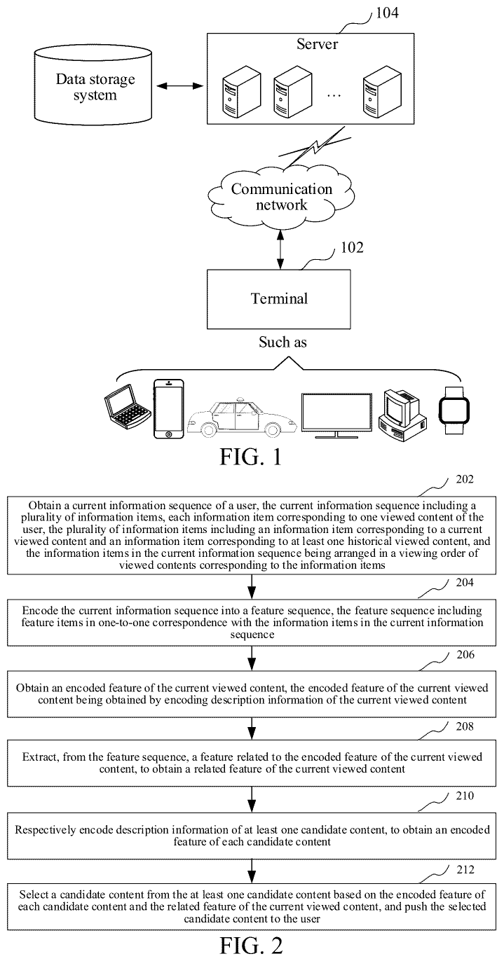

A content pushing method provided in some embodiments is applicable to an application environment shown in FIG. 1. A terminal 102 communicates with a server 104 through a network. A data storage system may store data to be processed by the server 104. The data storage system may be independently disposed, may be integrated onto the server 104, or may be placed on a cloud or another network server.

Specifically, in response to viewing of any content triggered by a user on a media platform, the terminal 102 sends a viewing request for the any content to the server 104. The any content is a content currently viewed, which is referred to as a current viewed content. The server 104 obtains a current information sequence of the user in response to the viewing request, the current information sequence including information items respectively corresponding to a plurality of viewed contents of the user, the information item including description information of a viewed content corresponding to the information item, and the plurality of viewed contents including the current viewed content and a historical viewed content; encodes the current information sequence into a feature sequence, the feature sequence including feature items in one-to-one correspondence with the information items in the current information sequence; obtains an encoded feature of the current viewed content, the encoded feature of the current viewed content being obtained by encoding description information of the current viewed content; extracts, from the feature sequence, a feature related to the encoded feature of the current viewed content, to obtain a related feature of the current viewed content; respectively encodes description information of at least one candidate content, to obtain an encoded feature of each candidate content; and selects a candidate content from the at least one candidate content based on the encoded feature of each candidate content and the related feature of the current viewed content, and pushes the selected candidate content to the user. When pushing the candidate content, the server may send push information of the candidate content to the terminal 102 of the user. The terminal 102 receives the push information sent by the server 104, and may display the push information in an interface provided by the media platform.

The terminal 102 may be, but is not limited to, various personal computers, notebook computers, smart phones, tablet computers, internet of things devices and portable wearable devices. The internet of things device may be a smart speaker, a smart television, a smart air conditioner, a smart vehicle-mounted device, or the like. The portable wearable device may be a smart watch, a smart band, a head-mounted device, or the like. The server 104 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a CDN, and a big data and artificial intelligence platform.

The content pushing method provided in this application may be based on an artificial intelligence technology. For example, a neural network model may be trained based on the artificial intelligence technology, and the current information sequence is encoded by using a trained neural network model, to obtain the feature sequence. Artificial intelligence (AI) is a theory, a method, a technology, and an application system that use a digital computer or a machine controlled by a digital computer to simulate, extend, and expand human intelligence, perceive an environment, obtain knowledge, and use the knowledge to obtain an optimal result. In other words, artificial intelligence is a comprehensive technology in computer science and attempts to understand the essence of intelligence and produce a new intelligent machine that can react in a manner similar to human intelligence. Artificial intelligence is to study the design principles and implementation methods of various intelligent machines, to enable the machines to have the functions of perception, reasoning, and decision-making. The artificial intelligence technology is a comprehensive discipline, and relates to a wide range of fields including both hardware-level technologies and software-level technologies. Basic artificial intelligence technologies generally include technologies such as a sensor, a dedicated artificial intelligence chip, cloud computing, distributed storage, a big data processing technology, a pre-training model technology, an operating/interaction system, and electromechanical integration. The pre-training model is also referred to as a big model or a basic model, and may be widely used in downstream tasks in various directions of artificial intelligence after fine-tuning. Artificial intelligence software technologies mainly include several major directions such as a computer vision technology, a speech processing technology, a natural language processing technology, and machine learning/deep learning.

Solutions provided in the embodiments of this application relate to technologies such as machine learning of artificial intelligence, and are described by using the following embodiments.

In some embodiments, as shown in FIG. 2, a content pushing method is provided. The method may be performed by a terminal or a server, or may be performed jointly by a terminal and a server. An example in which the method is applied to the server 104 in FIG. 1 is used for description, and the method includes operation 202 to operation 212 below.

Operation 202: Obtain a current information sequence of a user, the current information sequence including a plurality of information items, each information item corresponding to one viewed content of the user, the plurality of information items including an information item corresponding to a current viewed content and an information item corresponding to at least one historical viewed content, and the information items in the current information sequence being arranged in a viewing order of viewed contents corresponding to the information items.

The server may obtain the current information sequence of the user, the current information sequence including the information items respectively corresponding to the plurality of viewed contents of the user, the information item including description information of a viewed content corresponding to the information item, and the plurality of viewed contents including the current viewed content and the at least one historical viewed content.

The viewed content refers to content viewed by the user, and viewing refers to watching or browsing. The content includes, but is not limited to, one or more of a video, an audio, a picture, a text, a short film, a newspaper, an e-book, and the like. The video includes, but is not limited to, at least one of a long video or a short video. The user may be a user on a media platform. The viewed content may be a content viewed by the user on the media platform. The media platform disseminates a content through a network, and the media platform includes, but is not limited to, at least one of a live streaming platform, a video platform, a news platform, a novel platform, or a game platform. The video platform may be a platform providing short videos, or may be a platform providing short videos and long videos.

The current viewed content is a content viewed by the user at a current moment, for example, may be a video watched by the user on the video platform at the current moment. The historical viewed content is a content viewed by the user at a historical moment, for example, may be a video watched by the user on the video platform at the historical moment.

The current information sequence includes the information item corresponding to the current viewed content and the information item corresponding to the at least one historical viewed content. For example, the current information sequence includes information items respectively corresponding to N historical viewed contents. In the current information sequence, the information items corresponding to the viewed contents are sequentially arranged in a viewing order of the viewed contents, for example, sequentially arranged in a chronological viewing order. For example, a higher viewing ranking indicates a closer position of an information item corresponding to a viewed content to the beginning of the current information sequence. Because the current viewed content is viewed last, the information item corresponding to the current viewed content is a last information item in the current information sequence. For example, the current information sequence may be represented as: Seqᵤ={(item₁, side_info₁), (item₂, side_info₂) . . . (item_{N}, side_info_{N}), (item_{src}, side_info_{src})}. (itemᵢ, side_infoᵢ) is an information item of an i^{th} historical viewed content, where itemᵢ represents an identifier (id, Identity document) of the i^{th} historical viewed content, and side_info; represents description information of the i^{th} historical viewed content. 1≤i≤N. (item_{src}, side_info_{src}) is the information item of the current viewed content, where item_{src} represents an identifier of the current viewed content, and side_info_{src} represents description information of the current viewed content.

Description information of a viewed content is information configured for describing the viewed content. The description information of the viewed content may include information in at least one form of a text, an image, or a video. The description information of the viewed content may include at least one of a name of the viewed content, a tag of the viewed content, or a header image of the viewed content. The tag of the viewed content may be configured for indicating a type of the viewed content. The type includes, but is not limited to, at least one of humor, suspense, or the like. The header image refers to an image displayed at a head position of the viewed content. The description information of the viewed content may further include a part or all of the viewed content. The description information of the viewed content may further include information formed by integrating key characters or key plots in the viewed content.

Specifically, the server may obtain the description information of the current viewed content of the user, and obtain a historical information sequence of the user. The historical information sequence includes the information item corresponding to the at least one historical viewed content of the user. The information item corresponding to the historical viewed content includes description information of the historical viewed content. The server may generate the information item corresponding to the current viewed content based on the description information of the current viewed content, and generate the current information sequence of the user based on the information item corresponding to the current viewed content and the historical information sequence.

Operation 204: Encode the current information sequence into a feature sequence, the feature sequence including feature items in one-to-one correspondence with the information items in the current information sequence.

Specifically, the server may respectively encode the information items in the current information sequence, to obtain an encoded feature corresponding to each information item in each current information sequence. A feature item corresponding to an information item may be an encoded feature corresponding to the information item.

In some embodiments, the server may arrange the feature items respectively corresponding to the information items in an order in which the information items are arranged in the current information sequence, to obtain the feature sequence.

Operation 206: Obtain an encoded feature of the current viewed content, the encoded feature of the current viewed content being obtained by encoding the description information of the current viewed content.

Specifically, the server may encode the description information of the current viewed content, and determine a feature obtained through encoding as the encoded feature of the current viewed content.

In some embodiments, the description information of the current viewed content includes a plurality of pieces of information. The server may respectively encode the plurality of pieces of information to obtain an encoded value of each piece of information, and combine the encoded values of the plurality of pieces of information into the encoded feature of the current viewed content. The encoded feature of the current viewed content may be the encoded feature obtained through combination.

In some embodiments, because importance of the plurality of pieces of information in the description information of the current viewed content is different, some information includes a small amount of information, and some information includes a large amount of information. The server may generate a corresponding weight feature for the encoded feature of the current viewed content. The weight feature includes a weight corresponding to an encoded value of each piece of information in the encoded feature. The server may perform weighted calculation on the encoded feature of the current viewed content and the corresponding weight feature, and use a result of the weighted calculation as the encoded feature of the current viewed content. Specifically, the server may multiply an encoded value in the encoded feature of the current viewed content by a corresponding weight, to obtain a weighted value of each encoded value, and arrange the weighted values of the encoded values according to a manner in which the encoded values are arranged in the encoded feature, to obtain the encoded feature of the current viewed content. The encoded feature may be in a vector or matrix form. The vector form is used as an example. For example, the encoded feature of the current viewed content is Eₒ=[e₁, e₂, . . . , e_{f}], where e₁, e₂, . . . , and e_{f} are respectively the encoded values of the different items of information, and the weight feature is A₀=[a₁, a₂, . . . , a_{f}], where aⱼ is a weight of eⱼ, and l≤j≤f. The feature of the current viewed content is V₀=[V₁, V₂, . . . , v_{f}], where V₀ is a result obtained by multiplying each value in E₀ by a corresponding item in A₀, and vⱼ=aⱼ×eⱼ, to be specific, V₀ is a result obtained by performing a Hadamard product operation on E₀ and A₀. Through use of the weight feature, an encoded value including a small amount of information or unimportant information in the encoded feature may be attenuated. For example, when a weight is less than 1, an attenuation effect may be achieved, to reduce unimportant data in the encoded feature of the current viewed content as much as possible, and reduce interference generated by the unimportant data, thereby improving pushing accuracy.

In some embodiments, because the information item corresponding to the current viewed content includes the description information of the current viewed content, the encoded feature of the current viewed content may be obtained by encoding the information item corresponding to the current viewed content. Because the feature sequence includes a feature item corresponding to the current viewed content, and the feature item corresponding to the current viewed content is obtained by encoding the information item corresponding to the current viewed content, the server may use the feature item corresponding to the current viewed content in the feature sequence as the encoded feature of the current viewed content. Certainly, the server may not obtain the encoded feature item of the current viewed content from the feature sequence as the encoded feature of the current viewed content, but encode the information item corresponding to the current viewed content, to obtain an item encoded feature of the current viewed content, where the encoded feature of the current viewed content may be the item encoded feature of the current viewed content. The information item may also include a plurality of pieces of information. For a process of generating the item encoded feature of the current viewed content, refer to the process of generating the encoded feature of the current viewed content. In some embodiments, the server may generate a weight feature corresponding to the item encoded feature, and perform weighted calculation on the item encoded feature and the corresponding weight feature to obtain the encoded feature of the current viewed content. For a process of performing weighted calculation on the item encoded feature and the corresponding weight feature, refer to the foregoing process of performing weighted calculation on the encoded feature and the corresponding weight feature.

Operation 208: Extract, from the feature sequence, a feature related to the encoded feature of the current viewed content, to obtain a related feature of the current viewed content.

The related feature of the current viewed content is a feature that is extracted from the feature sequence and that is related to the encoded feature of the current viewed content.

Specifically, for each feature item, the server may extract, from the feature item, a feature related to the encoded feature of the current viewed content, to obtain a related item corresponding to the feature item. The server may generate the related feature of the current viewed content based on the related items respectively corresponding to the feature items.

In some embodiments, the server may arrange the related items respectively corresponding to the feature items in an order in which the feature items are arranged in the feature sequence, and use an arrangement result as the related feature of the current viewed content.

In some embodiments, the server may collect statistics about the related items respectively corresponding to the feature items, to obtain the related feature of the current viewed content. The statistics collection may be at least one of addition or multiplication. For example, the server may add the related items respectively corresponding to the feature items, to obtain the related feature of the current viewed content.

Operation 210: Encode description information of at least one candidate content, to obtain an encoded feature of each candidate content.

The candidate content is a preselected content. There may be a plurality of candidate contents, and the plurality of candidate contents refer to at least two candidate contents. A content pushed to the user is selected from the various candidate contents.

Specifically, the server may encode the description information of the candidate content, and determine a feature obtained through encoding as an encoded feature of the candidate content.

In some embodiments, the description information of the candidate content includes a plurality of pieces of information. The server may respectively encode the plurality of pieces of information to obtain an encoded value of each piece of information, and combine the encoded values of the plurality of pieces of information into the encoded feature of the candidate content. The encoded feature of the candidate content may be the encoded feature obtained through combination.

In some embodiments, because importance of the plurality of pieces of information in the description information of the candidate content is different, some information includes a small amount of information, and some information includes a large amount of information. The server may generate a corresponding weight feature for the encoded feature of the candidate content. The weight feature includes a weight corresponding to an encoded value of each piece of information in the encoded feature. The server may perform weighted calculation on the encoded feature of the candidate content and the corresponding weight feature, and use a result of the weighted calculation as the encoded feature of the candidate content. Specifically, the server may multiply an encoded value in the encoded feature of the candidate content by a corresponding weight, to obtain a weighted value of each encoded value, and arrange the weighted values of the encoded values according to a manner in which the encoded values are arranged in the encoded feature, to obtain the encoded feature of the candidate content.

In some embodiments, because an information item corresponding to the candidate content includes the description information of the candidate content, the encoded feature of the candidate content may be obtained by encoding the information item corresponding to the candidate content. The server may encode the information item corresponding to the candidate content, to obtain an item encoded feature of the candidate content, where the encoded feature of the candidate content may be the item encoded feature of the candidate content. The information item may also include a plurality of pieces of information. For a process of generating the item encoded feature of the candidate content, refer to the process of generating the encoded feature of the current viewed content. In some embodiments, the server may generate a weight feature corresponding to the item encoded feature, and perform weighted calculation on the item encoded feature and the corresponding weight feature to obtain the encoded feature of the candidate content. For a process of performing weighted calculation on the item encoded feature and the corresponding weight feature, refer to the foregoing process of performing weighted calculation on the encoded feature and the corresponding weight feature.

Operation 212: Select a candidate content from the at least one candidate content based on the encoded feature of each candidate content and the related feature of the current viewed content, and push the selected candidate content to the user.

Specifically, after obtaining the related feature of the current viewed content, the server may determine a recommendation score of the candidate content based on an encoded feature of the candidate content and the related feature of the current viewed content, select the candidate content from the at least one candidate content based on the recommendation score, and push the candidate content to the user.

In some embodiments, the related feature of the current viewed content obtained in operation 208 is referred to as a related feature of a first current viewed content. For each candidate content, the server may extract, from the feature sequence, a feature related to the encoded feature of the candidate content, to obtain a related feature of a second current viewed content corresponding to the candidate content. For each candidate content, the server may generate a comprehensive feature corresponding to the candidate content based on the related feature of the first current viewed content and the related feature of the second current viewed content corresponding to the candidate content. The server may predict the recommendation score of the candidate content based on the comprehensive feature corresponding to the candidate content. For a method for generating the related feature of the second current viewed content, refer to the method for generating the related feature of the first current viewed content.

In some embodiments, in response to viewing of any content triggered by the user on a media platform, the terminal sends a viewing request for the any content to the server. The any content is the current viewed content, and the viewing request may carry an identifier of the current viewed content and an identifier of the user. The server may store a historical information sequence set. The historical information sequence set includes historical information sequences of a plurality of users, and the historical information sequences in the historical information sequence set may be uniquely identified by using identifiers of the users. The server extracts the identifier of the current viewed content and the identifier of the user from the viewing request in response to the viewing request, searches the historical information sequence set for the corresponding historical information sequence based on the identifier of the user, determines the current viewed content based on the identifier of the current viewed content, obtains the description information of the current viewed content of the user, generates the information item corresponding to the current viewed content based on the identifier of the current viewed content and the description information of the current viewed content, adds the information item corresponding to the current viewed content based on the historical information sequence of the user to obtain the current information sequence of the user, and performs operations 204 to 212.

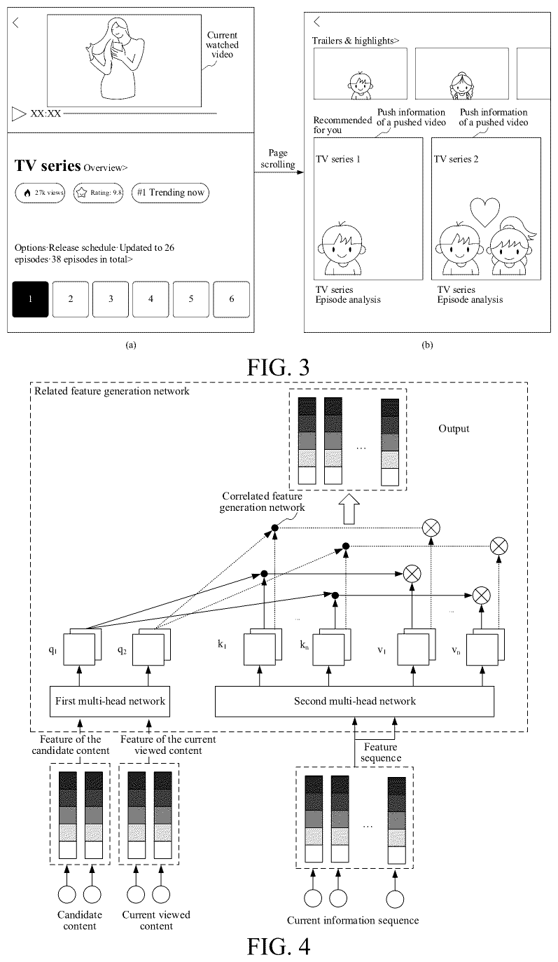

In some embodiments, when pushing the candidate content, the server may send push information of the candidate content to the terminal of the user. The push information may include at least one of a name, a title, popularity, a push reason, and the like of the candidate content, and certainly may further include other information. The push information may include information in at least one form of a picture, a text, an audio, or a video. The push information is not limited herein. The terminal receives the push information sent by the server, and may display the push information in an interface provided by the media platform. The push information may be displayed on a same page as the current viewed content, or may be displayed on a different page from the current viewed content. An example in which the content is a video is used. As shown in FIG. 3, (a) in FIG. 3 shows a current watched video, and (b) in FIG. 3 shows push information of a pushed video under a title “Recommended for you”. In FIG. 3, (a) and (b) belong to a same page. Because the page is long, (a) and (b) only show a part of the page, and (b) is triggered to be displayed upon triggering of an upward page swipe operation in (a).

In the foregoing content pushing method, the current information sequence includes the information items respectively corresponding to the plurality of viewed contents of the user, the information item includes description information of a corresponding viewed content, and the plurality of viewed contents include the current viewed content and the historical viewed content. Because the current viewed content reflects a real-time interest of the user, the current information sequence includes information that can reflect the real-time interest of the user, thereby improving real-time pushing accuracy. Moreover, the feature related to the encoded feature of the current viewed content is extracted from the feature sequence, to obtain the related feature of the current viewed content. Because the related feature of the current viewed content is related to the current viewed content, selecting the candidate content from the at least one candidate content based on the encoded feature of each candidate content and the related feature of the current viewed content, and pushing the selected candidate content to the user enhance impact of the current viewed content on content pushing, thereby making pushing better meet a real-time requirement, improving accuracy of real-time pushing, consuming fewer resources during achievement of a push target, and avoiding a waste of resources. For example, to achieve a push target that M persons clicks a pushed content after the content is pushed, pushing can be more accurate by using this solution, which means that a total quantity of contents that may be pushed to achieve the target is reduced, and time occupancy for implementing a push function is also reduced, thereby effectively improving resource utilization.

In some embodiments, the obtaining the current information sequence of the user includes: obtaining the description information of the current viewed content of the user; obtaining the historical information sequence of the user, the historical information sequence including the information item corresponding to the at least one historical viewed content of the user, the information item corresponding to the historical viewed content including the description information of the historical viewed content; generating the information item corresponding to the current viewed content based on the description information of the current viewed content; and generating the current information sequence of the user based on the information item corresponding to the current viewed content and the historical information sequence.

The historical information sequence includes a plurality of information items, where a plurality of means at least two. An information item in the historical information sequence is an information item corresponding to a historical viewed content of the user. In the historical information sequence, the information items are sequentially arranged in a viewing order of the historical viewed contents, for example, sequentially arranged in a chronological viewing order. For example, a higher viewing ranking indicates a closer position of an information item to the beginning of the historical information sequence. For example, if the historical information sequence includes information items corresponding to N historical viewed contents, the historical information sequence may be represented as: Seq={(item₁, side_info₁), (item₂, side_info₂ . . . (item_{N}, side_info_{N})}. (itemᵢ, side_infoᵢ) represents an information item corresponding to an i^{th} historical viewed content, where itemᵢ represents an identifier of the i^{th} historical viewed content, and side_info; represents description information of the i^{th} historical viewed content. l≤i≤N. Before the user views the current viewed content, the historical information sequence of the user already exists.

Specifically, the server may combine the identifier of the current viewed content and the description information of the current viewed content, to generate the information item corresponding to the current viewed content. For example, the information item corresponding to the current viewed content may be represented as (item_{src}, side_info_{src}), where item_{src} represents the identifier of the current viewed content, and side_info_{src} represents the description information of the current viewed content.

In some embodiments, the server may add the information item corresponding to the current viewed content based on the historical information sequence to generate the current information sequence. Specifically, the server may add the information item corresponding to the current viewed content to the historical information sequence according to the viewing order to generate the current information sequence. For example, if the information items in the historical information sequence are arranged in the chronological viewing order, because the current viewed content is the last in the viewing order, the information item corresponding to the current viewed content is added after a last information item in the historical information sequence to generate the current information sequence. That is, a last information item in the current information sequence is the information item corresponding to the current viewed content.

In some embodiments, when viewing of a content is triggered, an information item corresponding to the content cannot be updated to the historical information sequence in time. In other words, when viewing of a content is triggered, the historical information sequence obtained by the server does not include an information item corresponding to the content. Therefore, a real-time requirement may not be satisfied if the historical information sequence is directly used for content pushing. The current information sequence is generated based on the information item corresponding to the current viewed content and the historical information sequence. Because the current viewed content is the content viewed by the user at the current moment, the current viewed content reflects the real-time interest of the user. Therefore, the current information sequence covers the information that can reflect the real-time interest of the user, thereby resolving a disadvantage that the historical information sequence cannot be updated in time. Content pushing is performed based on the current information sequence, thereby improving accuracy of real-time pushing, and further reducing a waste of resources.

In some embodiments, the extracting, from the feature sequence, the feature related to the encoded feature of the current viewed content, to obtain the related feature of the current viewed content includes: combining each feature item in the feature sequence with the encoded feature of the current viewed content, to obtain a combined feature corresponding to the feature item; fusing each feature item and the combined feature corresponding to the feature item, to obtain a related item corresponding to the feature item; and generating the related feature of the current viewed content based on the related items respectively corresponding to the feature items.

The combination includes, but is not limited to, at least one of concatenation or fusion, and the fusion includes at least one of addition, subtraction, or multiplication. The feature that is extracted from the feature item and that is related to the encoded feature of the current viewed content is referred to as the related item corresponding to the feature item.

Specifically, one feature item is used as an example to describe a process of generating a combined feature corresponding to the feature item: The server may add the feature item and the encoded feature of the current viewed content, to obtain a first added feature. The adding refers to summing data at a same position. In some embodiments, the server may subtract the encoded feature of the current viewed content from the feature item, to obtain a first subtracted feature. The subtraction refers to performing difference calculation on data at a same position. In some embodiments, the server may multiply the feature item by the encoded feature of the current viewed content, to obtain a first multiplied feature. The multiplication refers to performing a product operation on data at a same position. In other words, the multiplication refers to performing a Hadamard product operation. The server may concatenate at least two of the first added feature, the first subtracted feature, or the first multiplied feature, and use a concatenation result as the combined feature corresponding to the feature item. In some embodiments, the server may concatenate at least two of the first added feature, the first subtracted feature, the first multiplied feature, the feature item, or the encoded feature of the current viewed content, and use a concatenation result as the combined feature corresponding to the feature item.

In some embodiments, for the combined feature corresponding to each feature item, the server may perform further feature extraction on the combined feature, to obtain a correlated feature corresponding to the feature item. The further feature extraction may be implemented by using a neural network, which includes, but is not limited to, being implemented by using at least one of a fully connected neural network or a convolutional neural network. The correlated feature represents a relationship between the feature item and the encoded feature of the current viewed content.

In some embodiments, one feature item is used as an example to describe a process of generating the related feature of the current viewed content corresponding to the feature item: The server may fuse, for example, perform a Hadamard product operation on, the feature item and the correlated feature corresponding to the feature item, and determine a result of the operation as the related item corresponding to the feature item, for example, as the feature of the feature item related to the encoded feature of the current viewed content.

In some embodiments, the server may collect statistics on, for example, sum, the related items respectively corresponding to the feature items, to obtain the related feature of the current viewed content. Certainly, the server may generate the related feature of the current viewed content by using another method, for example, may generate the related feature of the current viewed content by using an attention mechanism principle.

In some embodiments, through the combination, feature extraction, and fusion, the feature of each feature item related to the encoded feature of the current viewed content is automatically generated, to obtain the related item corresponding to the feature item, and the related feature of the current viewed content is generated based on the related items, thereby improving efficiency of generating the related feature of the current viewed content.

In some embodiments, the combining each feature item in the feature sequence with the encoded feature of the current viewed content, to obtain a combined feature corresponding to the feature item includes: performing first dimension-increasing processing on each feature item in the feature sequence, to obtain a first dimension-increased feature corresponding to the feature item, and performing second dimension-increasing processing on each feature item, to obtain a second dimension-increased feature corresponding to the feature item; performing third dimension-increasing processing on the encoded feature of the current viewed content, to obtain a third dimension-increased feature; and combining the first dimension-increased feature corresponding to each feature item and the third dimension-increased feature, to obtain the combined feature corresponding to the feature item; and the fusing each feature item and the combined feature corresponding to the feature item, to obtain a related item corresponding to the feature item includes: fusing the second dimension-increased feature and the combined feature that correspond to each feature item, to obtain the feature of the feature item related to the encoded feature of the current viewed content, and obtain the related item corresponding to the feature item.

The dimension-increasing processing is processing used for increasing a dimension, and may be implemented through upsampling. Upsampling methods respectively used for the first dimension-increasing processing, the second dimension-increasing processing, and the third dimension-increased feature may be the same or may be different. For a same feature item, a corresponding first dimension-increased feature and a corresponding second dimension-increased feature may be the same or may be different.

The dimension is a dimension of a vector or a matrix. The dimension of a vector is a quantity of values included in the vector. For example, a dimension of a vector including four values is 4. The dimension of a matrix is determined based on a quantity of rows and a quantity of columns. Certainly, the dimension-increasing processing may be implemented by using a neural network, which includes, but is not limited to, at least one of a convolutional neural network or a fully connected neural network. The combination includes, but is not limited to, at least one of concatenation or fusion, and the fusion includes, but is not limited to, at least one of addition, subtraction, or multiplication.

Specifically, one feature item is used as an example to describe a process of generating the combined feature corresponding to the feature item: The server may fuse the first dimension-increased feature corresponding to the feature item and the third dimension-increased feature, to obtain a dimension-increased fusion feature corresponding to the feature item; and concatenate the dimension-increased fusion feature corresponding to the feature item, the first dimension-increased feature corresponding to the feature item, and the third dimension-increased feature, to obtain the combined feature corresponding to the feature item.

In some embodiments, for the combined feature corresponding to each feature item, the server may perform further feature extraction on the combined feature, to obtain the correlated feature corresponding to the feature item. The further feature extraction may be implemented by using a neural network, which includes, but is not limited to, being implemented by using at least one of a fully connected neural network or a convolutional neural network. The correlated feature represents a relationship between the feature item and the encoded feature of the current viewed content.

In some embodiments, one feature item is used as an example to describe a process of generating the related feature of the current viewed content corresponding to the feature item: The server may fuse, for example, perform a Hadamard product operation on, the second dimension-increased feature corresponding to the feature item and the correlated feature corresponding to the feature item, and determine a result of the operation as the related item corresponding to the feature item.

In some embodiments, the server may collect statistics on, for example, sum, the related items respectively corresponding to the feature items, to obtain a first statistical feature. The related feature of the current viewed content may be the first statistical feature. In some embodiments, the server may perform dimension-reduction processing on the first statistical feature, to obtain the related feature of the current viewed content. The dimension-reduction processing is processing of reducing the number of dimensions, and may be implemented through downsampling. A downsampling method is not limited.

In some embodiments, the server may generate the related feature of the current viewed content through a related feature generation network of the current viewed content. The related feature generation network of the current viewed content is a neural network and is trained. The related feature generation network of the current viewed content includes at least one multi-head network. The multi-head network is configured for performing dimension-increasing processing. For example, the related feature generation network of the current viewed content includes a first multi-head network and a second multi-head network. The first multi-head network is configured for performing dimension-increasing processing on the encoded feature of the candidate content and the encoded feature of the current viewed content. The second multi-head network is configured for performing dimension-increasing processing on the feature item in the feature sequence. The multi-head network may include a plurality of sub-network units, each sub-network unit has a corresponding parameter, and each sub-network unit is configured to transform a feature input into the multi-head network into a new feature. Therefore, inputting one feature into the multi-head network means inputting a plurality of new features into the multi-head network, thereby achieving dimension increase. For example, if the multi-head network includes m sub-network units, m new features are output, where the m new features form a dimension-increased feature.

As shown in FIG. 4, a diagram of a structure of the related feature generation network is shown. The third dimension-increasing processing may be implemented through the first multi-head network, and q₂ represents the third dimension-increased feature obtained by performing third dimension-increasing processing on the feature of the current viewed content. The first dimension-increasing processing and the second dimension-increasing processing may be implemented through the second multi-head network, n represents a quantity of the feature items included in the feature sequence, and k₁ to kₙ respectively represent first dimension-increased features corresponding to a 1^{st} feature item to an n^{th} feature item. v₁ to vₙ respectively represent second dimension-increased features corresponding to the 1^{st} feature item to the n^{th} feature item. If the second multi-head network includes m sub-network units, both the first dimension-increased feature and the second dimension-increased feature include m new features. For example, kₙ may be expressed as kₙ=(kₙ¹, kₙ² . . . kₙ^{m}). kₙ¹ to kₙ^{m} are the m new features generated through the second multi-head network.

In some embodiments, the server inputs the feature sequence and the encoded feature of the current viewed content into the related feature generation network of the current viewed content, generates the combined feature corresponding to each feature item in the network based on the related feature of the current viewed content, through the related feature generation network of the current viewed content, fuses, for example, performs a Hadamard product operation on, the second dimension-increased feature and the combined feature that correspond to each feature item, to obtain the related item corresponding to the feature item, and generates the related feature of the current viewed content based on the related items respectively corresponding to the feature items.

In some embodiments, the features obtained through the dimension-increasing processing are combined, so that the combination and the fusion are more deeply performed, and the generated related feature of the current viewed content is more accurate.

In some embodiments, the combining the first dimension-increased feature corresponding to each feature item and the third dimension-increased feature, to obtain the combined feature corresponding to the feature item includes: fusing the first dimension-increased feature corresponding to each feature item and the third dimension-increased feature, to obtain the dimension-increased fusion feature corresponding to the feature item; and for each feature item, concatenating the dimension-increased fusion feature corresponding to the feature item, the first dimension-increased feature corresponding to the feature item, and the third dimension-increased feature, to obtain the combined feature corresponding to the feature item.

Specifically, the fusion includes at least one of addition, subtraction, or multiplication. One feature item is used as an example to describe a process of generating the combined feature corresponding to the feature item: The server may add the first dimension-increased feature corresponding to the feature item and the third dimension-increased feature, to obtain a second added feature. The adding refers to summing data at a same position. In some embodiments, the server may subtract the third dimension-increased feature from the first dimension-increased feature corresponding to the feature item, to obtain a second subtracted feature. The subtraction refers to performing difference calculation on data at a same position. In some embodiments, the server may multiply the first dimension-increased feature corresponding to the feature item by the third dimension-increased feature, to obtain a second multiplied feature. The multiplication refers to performing a product operation on data at a same position. In other words, the multiplication refers to performing a Hadamard product operation. The server may concatenate at least two of the second added feature, the second subtracted feature, or the second multiplied feature, and use a concatenation result as the combined feature corresponding to the feature item. In some embodiments, the server may concatenate at least two of the second added feature, the second subtracted feature, the second multiplied feature, the first dimension-increased feature corresponding to the feature item, and the third dimension-increased feature, and use a concatenation result as the combined feature corresponding to the feature item. For example, the server may concatenate the second added feature, the second subtracted feature, the second multiplied feature, the first dimension-increased feature corresponding to the feature item, and the third dimension-increased feature, and use a concatenation result as the combined feature corresponding to the feature item. The second added feature, the second subtracted feature, and the second multiplied feature are respectively one dimension-increased fusion feature.

In some embodiments, the combined feature is generated by means of fusion and concatenation, so that the features are deeply combined, and useful information included in the combined feature is improved.

In some embodiments, the encoding the current information sequence into the feature sequence includes: respectively encoding the information items in the current information sequence, to obtain the encoded feature of each information item; generating a corresponding weight feature for the encoded feature of each information item; weighting the encoded feature of each information item and the weight feature corresponding to the information item, to obtain a feature item corresponding to the information item; and obtaining the feature sequence by arranging the feature items respectively corresponding to the information items.

Specifically, the information item may include a plurality of pieces of information. For each information item, the server may respectively encode the plurality of pieces of information in the information item to obtain an encoded value of each piece of information, and combine the encoded values of the plurality of pieces of information into the encoded feature of the information item. The server may arrange the encoded features of the information items in the order in which the information items are arranged in the current information sequence, to obtain an encoded feature sequence. The server may generate the corresponding weight feature for the encoded feature of each information item in the encoded feature sequence. The weight feature corresponding to the encoded feature of the information item includes weights respectively corresponding to the encoded values in the encoded feature of the information item. For each information item, the server may perform weighted calculation on the encoded feature of the information item and the weight feature corresponding to the information item, and use a result of the weighted calculation as the feature item corresponding to the information item.

In some embodiments, the server may multiply an encoded value in the encoded feature of the information item by a corresponding weight, to obtain a weighted value of each encoded value, and arrange the weighted values of the encoded values according to a manner in which the encoded values are arranged in the encoded feature, to obtain the feature item corresponding to the information item.

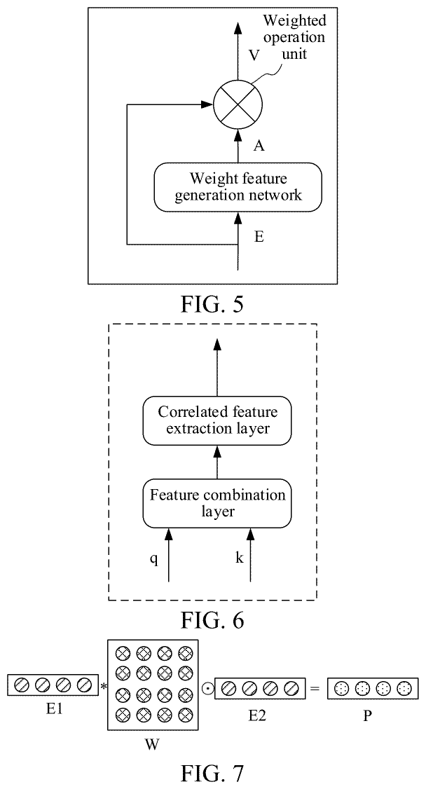

In some embodiments, the server may generate the weight feature through a neural network and weight the encoded feature and the weight feature. For example, the server may generate the weight feature through a feature extraction network and weight the encoded feature and the weight feature. The feature extraction network is trained. As shown in FIG. 5, a diagram of a structure of the feature extraction network is shown. The feature extraction network includes a weight feature generation network and a weighted operation unit. An encoded feature E of an information item is input into the weight feature generation network to obtain a weight feature A corresponding to E, E and A are input into the weighted operation unit, and the weighted operation unit multiplies E by A, to obtain a feature item corresponding to the information item.

In some embodiments, the feature extraction network includes a plurality of layers of sub-networks. The plurality of layers refers to at least two layers. Each sub-network may be implemented by using a fully connected neural network (Multi-Layer Perception, MLP), for example, the sub-network may be a fully connected layer. An example in which the feature extraction network includes two layers of sub-networks is used. Parameters of a 1^{st} layer of sub-network include w₁ and c₁, and parameters of a 2^{nd} layer of sub-network include w₂ and c₂, where both c₁ and c₂ are activation functions. w₁ is a matrix with f rows and f/c₃ columns, w₁ is a matrix with f/c₃ rows and f columns, and c₃ is a reduction ratio parameter. During training, w₁ and w₂ are parameters that may be learned. Therefore, the weight feature A may be expressed as: A=Fex(E)=c₂(w₂c₁(w₁E)), where Fex represents the feature extraction network.

In some embodiments, through use of the weight feature, an encoded value including a small amount of information or unimportant information in the encoded feature may be attenuated, to reduce unimportant data in the feature item as much as possible, and reduce interference generated by the unimportant data, thereby improving pushing accuracy.

In some embodiments, the selecting the candidate content from the at least one candidate content based on the encoded feature of each candidate content and the related feature of the current viewed content, and pushing the selected candidate content to the user includes: for each candidate content, generating a comprehensive feature corresponding to the candidate content based on the encoded feature of the candidate content and the related feature of the current viewed content; predicting a recommendation score of each candidate content based on the comprehensive feature corresponding to the candidate content; and selecting the candidate content from the at least one candidate content based on the recommendation score, and pushing the selected candidate content to the user.

Specifically, the server may generate a recommendation score for each of a plurality of candidate contents. An example in which a recommendation score is generated for one candidate content is used. The server may concatenate an encoded feature of the candidate content and the related feature of the current viewed content, to generate a comprehensive feature corresponding to the candidate content, and predict the recommendation score of the candidate content based on the comprehensive feature corresponding to the candidate content. The server may further perform feature extraction on the related feature of the current viewed content, and concatenate an extracted feature and the encoded feature of the candidate content, to generate the comprehensive feature corresponding to the candidate content.

In some embodiments, the server may select a candidate content with a highest recommendation score from the plurality of candidate contents, and push the selected candidate content to the user. In some embodiments, the server may select a preset quantity of candidate contents from the plurality of candidate contents according to descending order of recommendation scores, and push the selected candidate contents to the user. The preset quantity may be set as required, for example, may be 5, 10, 12, or the like.

In some embodiments, because the comprehensive feature is generated based on the encoded feature of the candidate content and the related feature of the current viewed content, the recommendation score predicted based on the comprehensive feature better conforms to a current situation, so that the candidate content meeting a real-time requirement can be selected based on the recommendation score for pushing, thereby improving pushing accuracy.

In some embodiments, the related feature of the current viewed content is the related feature of the first current viewed content, and the generating a comprehensive feature corresponding to the candidate content based on the encoded feature of the candidate content and the related feature of the current viewed content includes: extracting, from the feature sequence, the feature related to the encoded feature of the candidate content, to obtain the related feature of the second current viewed content corresponding to the candidate content; and generating the comprehensive feature corresponding to the candidate content based on the related feature of the first current viewed content and the related feature of the second current viewed content corresponding to the candidate content.

The related feature of the current viewed content obtained in operation 208 (for example, the operation: Extract, from the feature sequence, a feature related to the encoded feature of the current viewed content, to obtain a related feature of the current viewed content) is referred to as the related feature of the first current viewed content. The combined feature in the operation “combining each feature item in the feature sequence with the encoded feature of the current viewed content, to obtain a combined feature corresponding to the feature item” is referred to as a first combined feature. The correlated feature obtained in the operation “performing further feature extraction on the combined feature, to obtain a correlated feature corresponding to the feature item” is referred to as a first correlated feature. The related item obtained in the operation “fusing each feature item and the combined feature corresponding to the feature item, to obtain a related item corresponding to the feature item” is referred to as a first related item.

Specifically, the server may perform fourth dimension-increasing processing on the encoded feature of the candidate content, to obtain a fourth dimension-increased feature. For each feature item, the server may combine the first dimension-increased feature corresponding to the feature item and the fourth dimension-increased feature, to obtain a second combined feature corresponding to the feature item. The fourth dimension-increasing processing may be implemented through the first multi-head network. As shown in FIG. 4, q₁ represents the fourth dimension-increased feature obtained by performing fourth dimension-increasing processing on the encoded feature of the candidate content. For each feature item, the server may perform feature extraction on the second combined feature, to obtain a second correlated feature. The second correlated feature represents a relationship between the feature item and the encoded feature of the candidate content. The server may fuse the second correlated feature and the second dimension-increased feature, to obtain a second related item corresponding to the feature item. The server may collect statistics on, for example, sum, the second related items respectively corresponding to the feature items, to obtain a second statistical feature. The related feature of the second current viewed content may be the second statistical feature. In some embodiments, the server may perform dimension-reduction processing on the second statistical feature, to obtain the related feature of the second current viewed content.

In some embodiments, as shown in FIG. 4, the related feature generation network of the current viewed content further includes a correlated feature generation network. As shown in FIG. 6, a diagram of a structure of the correlated feature generation network is shown. The correlated feature generation network includes a feature combination layer and a correlated feature extraction layer. The combined features (the first combined feature and the second combined feature) may be generated through the feature combination layer, and the correlated features (the first correlated feature and the second correlated feature) may be generated through the correlated feature extraction layer. q in FIG. 6 may be any one of q₁ or q₂, and k may be any one of kₙ¹ to kₙ^{m}. The correlated feature extraction layer may be implemented by using a fully connected neural network (Multi-Layer Perception, MLP) or a convolutional neural network, and the feature combination layer is configured for combining input q and k. An output of the correlated feature generation network may be expressed as fₐₜₜ₋ₒᵤₜ=MLP((q+k), (q−k), (q*k), q, k), where MLP represents the correlated feature extraction layer, (q+k), (q−k), and (q*k) are obtained through the feature combination layer, (q+k), (q−k), (q*k), q, and k are concatenated to obtain a combined feature (for example, the first combined feature or the second combined feature), and the combined feature is input into the MLP, for example, the correlated feature extraction layer, to obtain a correlated feature fₐₜₜ₋ₒᵤₜ, where fₐₜₜ₋ₒᵤₜ is the correlated feature, for example, the first correlated feature or the second correlated feature.

In some embodiments, in FIG. 4, if data input into the related feature generation network of the current viewed content is the feature sequence and the encoded feature of the current viewed content, the related feature generation network of the current viewed content outputs the related feature of the first current viewed content. If data input into the related feature generation network of the current viewed content is the feature sequence and the encoded feature of the candidate content, the related feature generation network of the current viewed content outputs the related feature of the second current viewed content. If data input into the related feature generation network of the current viewed content is the feature sequence, the encoded feature of the current viewed content, and the encoded feature of the candidate content, the server may further determine a weighting weight of the related feature of the first current viewed content through the related feature generation network of the current viewed content, to obtain a first weighting weight, determine a weighting weight of the related feature of the second current viewed content corresponding to the candidate content, to obtain a second weighting weight, and perform weighted calculation on the related feature of the first current viewed content and the related feature of the second current viewed content by using the first weighting weight and the second weighting weight, to obtain a related feature of a target current viewed content corresponding to the candidate content. For example, the related feature of the target current viewed content=the first weighting weight*the related feature of the first current viewed content+the second weighting weight*the related feature of the second current viewed content. The comprehensive feature corresponding to the candidate content may be the related feature of the target current viewed content corresponding to the candidate content. For example, the related feature of the target current viewed content may be expressed as:

$${F}_{AAoutput} = g * {\sum }_{i = 1}^{N + 1} f ( {q}_{1} , {k}_{i} , {v}_{i} ) + ( 1 - g ) * {\sum }_{i = 1}^{N + 1} f ( {q}_{2} , {k}_{i} , {v}_{i} ) = g * {\sum }_{i = 1}^{N + 1} {f}_{att} ( h ( {E}_{t} ) , h ( {e}_{i} ) ) + ( 1 - g ) * {\sum }_{i = 1}^{N + 1} {f}_{att} ( h ( {E}_{SRC} ) , h ( {e}_{i} ) )$$

g is the second weighting weight, (1−g) is the first weighting weight, E_{src} is the encoded feature of the current viewed content, Eₜ is the encoded feature of the candidate content, eᵢ represents an i^{th} feature item in the feature sequence, f(q₂, kᵢ, vᵢ) and fₐₜₜ(h(E_{SRC}), h(eᵢ)) both represent a first related item corresponding to the i^{th} feature item,

$${\sum }_{i = 1}^{N + 1} {f}_{att} ( h ( {E}_{SRC} ) , h ( {e}_{i} ) )$$

f(q₁, kᵢ, vᵢ) and fₐₜₜ(h(Eₜ), h(eᵢ) both represent a second related item corresponding to the i^{th} feature item,

$${\sum }_{i = 1}^{N + 1} {f}_{att} ( h ( {E}_{t} ) , h ( {e}_{i} ) )$$

represents the related feature of the second current viewed content, kᵢ represents the first dimension-increased feature obtained by performing first dimension-increasing processing on eᵢ, and vᵢ represents the second dimension-increased feature obtained by performing second dimension-increasing processing on eᵢ.

In some embodiments, the server may concatenate the encoded feature of the current viewed content and the related feature of the target current viewed content corresponding to the candidate content, to obtain the comprehensive feature. In some embodiments, the server may perform further feature extraction on the related feature of the target current viewed content, to obtain an extracted related feature, and obtain the comprehensive feature based on the extracted related feature. For example, the server may use the extracted related feature as the comprehensive feature, or may concatenate the encoded feature of the current viewed content and the extracted related feature, to obtain the comprehensive feature corresponding to the candidate content.

In some embodiments, the related feature of the second current viewed content is related to the candidate content, so that the comprehensive feature is affected by the candidate content, and the recommendation score predicted based on the comprehensive feature is affected by the candidate content, thereby improving rationality of the recommendation score.

In some embodiments, the generating a comprehensive feature corresponding to the candidate content based on the encoded feature of the candidate content and the related feature of the current viewed content includes: fusing the encoded feature of the current viewed content and the encoded feature of the candidate content, to obtain a content fusion feature corresponding to the candidate content; and generating the comprehensive feature corresponding to the candidate content based on the content fusion feature corresponding to the candidate content and the related feature of the current viewed content.

Specifically, the server may perform at least one calculation of addition, subtraction, or multiplication on the encoded feature of the candidate content and the encoded feature of the current viewed content, and use a result of the calculation as the content fusion feature corresponding to the candidate content.

In some embodiments, the server may fuse the encoded feature of the current viewed content and the encoded feature of the candidate content through a neural network, to obtain the content fusion feature corresponding to the candidate content. The server may multiply the encoded feature of the current viewed content by a parameter matrix of the neural network, and then perform a Hadamard product operation on a result obtained through the multiplication and the encoded feature of the candidate content, to obtain the content fusion feature corresponding to the candidate content. The parameter matrix is a matrix formed by parameters in the neural network. For example, the encoded feature of the current viewed content is E₁, the encoded feature of the candidate content is E₂, and the parameter matrix is W. In this case, the content fusion feature P=Hadamard product operation (E₁*W, E₂), where Hadamard product operation (E₁*W, E₂) denotes calculating a Hadamard product of E₁*W and E₂, and P represents the content fusion feature. A process of generating the content fusion feature may also be referred to as a feature crossing process. An example in which both E₁ and E₂ are vectors, and W is a matrix is used. As shown in FIG. 7, a diagram of a principle of generating the content fusion feature is shown. In FIG. 7, both E₁ and E₂ are 4-dimensional vectors, W is a matrix with four rows and four columns, and an obtained P is a 4-dimensional vector.

In some embodiments, the server may concatenate the content fusion feature corresponding to the candidate content and the related feature of the first current viewed content, to generate the comprehensive feature corresponding to the candidate content. In some embodiments, the server may perform further feature extraction on the related feature of the first current viewed content, to obtain an extracted related feature corresponding to the related feature of the first current viewed content, and concatenate the extracted related feature corresponding to the related feature of the first current viewed content and the content fusion feature corresponding to the candidate content, to generate the comprehensive feature corresponding to the candidate content.

In some embodiments, the server may obtain description information of the user. The description information of the user includes at least one piece of data of a user identifier, a user age, a user location, a user device, points of interest, a category preferred by the user, or the like. The server may encode the description information of the user, to obtain a feature of the user, and fuse the feature of the user and the encoded feature of the candidate content, to obtain a user fusion feature corresponding to the candidate content. For a process of obtaining the user fusion feature, refer to the process of obtaining the content fusion feature.

In some embodiments, the server may encode the description information of the user, to obtain an information-encoded feature. The description information of the user includes a plurality of pieces of information. The server may respectively encode the plurality of pieces of information to obtain an encoded value of each piece of information, and combine the encoded values of the plurality of pieces of information into the information-encoded feature. The feature of the user may be the information-encoded feature.

In some embodiments, a feature embedding vector (embedding vector) is encoded. The server may encode discrete data in the description information of the user, and keep continuous data unchanged, to obtain an encoded feature of the user. The discrete data is, for example, a user identifier. For the discrete data, especially high-dimensional sparse discrete data, in the description information of the user, the server may generate an embedding vector (embedding vector) corresponding to the discrete data.

In some embodiments, the server may use the information-encoded feature as the feature of the user. In some embodiments, the server may generate a corresponding weight feature for the information-encoded feature. The weight feature includes a weight corresponding to an encoded value of each piece of information in the information-encoded feature. The server may perform weighted calculation, for example, a Hadamard product operation, on the information-encoded feature and the corresponding weight feature, and use a result of the operation as the feature of the user. For a process of the weighted calculation, refer to content related to the encoded feature of the current viewed content.

In some embodiments, the server may generate the comprehensive feature corresponding to the candidate content based on the user fusion feature corresponding to the candidate content, the content fusion feature corresponding to the candidate content, and the related feature of the first current viewed content. The server may concatenate the user fusion feature, the content fusion feature, and the related feature of the first current viewed content to generate the comprehensive feature.

In some embodiments, the server may generate the comprehensive feature corresponding to the candidate content based on the related feature of the first current viewed content, the related feature of the second current viewed content corresponding to the candidate content, and the content fusion feature corresponding to the candidate content. The server may determine the weighting weight of the related feature of the first current viewed content, to obtain the first weighting weight, determine the weighting weight of the related feature of the second current viewed content corresponding to the candidate content, to obtain the second weighting weight, perform weighted calculation on the related feature of the first current viewed content and the related feature of the second current viewed content by using the first weighting weight and the second weighting weight, to obtain the related feature of the target current viewed content corresponding to the candidate content, and concatenate the related feature of the target current viewed content corresponding to the candidate content and the content fusion feature corresponding to the candidate content, to generate the comprehensive feature corresponding to the candidate content. In some embodiments, the server may perform further feature extraction on the related feature of the target current viewed content, to obtain an extracted target feature corresponding to the candidate content, and concatenate the extracted target feature corresponding to the candidate content and the content fusion feature corresponding to the candidate content, to generate the comprehensive feature corresponding to the candidate content.

In some embodiments, the server may generate the comprehensive feature corresponding to the candidate content based on the related feature of the first current viewed content, the content fusion feature corresponding to the candidate content, and the encoded feature of the current viewed content. The server may concatenate the related feature of the first current viewed content, the content fusion feature corresponding to the candidate content, and the encoded feature of the current viewed content, to generate the comprehensive feature corresponding to the candidate content. In some embodiments, the server may perform further feature extraction on the related feature of the first current viewed content, to obtain an extracted related feature corresponding to the related feature of the first current viewed content, and concatenate the extracted related feature corresponding to the related feature of the first current viewed content, the content fusion feature corresponding to the candidate content, and the encoded feature of the current viewed content, to generate the comprehensive feature corresponding to the candidate content.

In some embodiments, the server may encode context information of the user, to obtain an encoded feature of the context information. The context information refers to an environment in which the current viewed content is presented, including a scenario in which the current viewed content is presented on the media platform and information about a device on which the current viewed content is presented. The context information includes a plurality of pieces of information, and the server may respectively encode the plurality of pieces of information to obtain an encoded value of each piece of information, and combine the encoded values of the plurality of pieces of information into an encoded feature of the context information. The server may obtain a feature of the context information based on the encoded feature of the context information, for example, use the encoded feature of the context information as the feature of the context information. In some embodiments, the server may generate a corresponding weight feature for the encoded feature of the context information. The weight feature includes a weight corresponding to an encoded value of each piece of information in the encoded feature of the context information. The server may perform weighted calculation, for example, a Hadamard product operation, on the encoded feature of the context information and the corresponding weight feature, and use a result of the operation as the feature of the context information of the user. For a process of the weighted calculation, refer to content related to the encoded feature of the current viewed content.

In some embodiments, the server may fuse the feature of the context information and the encoded feature of the candidate content, to generate a context fusion feature corresponding to the candidate content. For a method for generating the context fusion feature, refer to the method for generating the content fusion feature. The server may generate the comprehensive feature corresponding to the candidate content based on the context fusion feature of the user, the content fusion feature corresponding to the candidate content, and the related feature of the first current viewed content. The server may concatenate the context fusion feature, the content fusion feature corresponding to the candidate content, and the related feature of the first current viewed content, to generate the comprehensive feature corresponding to the candidate content.

In some embodiments, the server may concatenate at least one of the content fusion feature, the user fusion feature, the context fusion feature, and the related feature of the second current viewed content corresponding to the candidate content and the related feature of the first current viewed content, to generate the comprehensive feature corresponding to the candidate content.

In some embodiments, the server may concatenate at least one of the content fusion feature, the user fusion feature, the context fusion feature, and the related feature of the second current viewed content, the related feature of the first current viewed content, and the encoded feature of the current viewed content, to generate the comprehensive feature corresponding to the candidate content. The server may concatenate at least one of the content fusion feature, the user fusion feature, and the context fusion feature, the related feature of the target current viewed content corresponding to the candidate content, and the encoded feature of the current viewed content, to generate the comprehensive feature corresponding to the candidate content. The content fusion feature, the user fusion feature, and the context fusion feature may be obtained through a feature crossing network. The feature crossing network is trained, and a principle of the feature crossing network is shown in FIG. 7. W in FIG. 7 is a parameter of the feature crossing network. For example, the server may concatenate the encoded feature of the candidate content and the encoded feature of the current viewed content, and input a concatenated encoded feature into the feature crossing network, to generate the content fusion feature. Similarly, the user fusion feature and the context fusion feature may be generated.

In some embodiments, the encoded feature of the current viewed content and the encoded feature of the candidate content are fused, thereby enhancing impact of the current viewed content on generation of the comprehensive feature, so that the recommendation score predicted based on the comprehensive feature better meets a real-time requirement, thereby improving accuracy of real-time pushing.

In some embodiments, the predicting a recommendation score of each candidate content based on the comprehensive feature corresponding to the candidate content includes: for each candidate content, determining a feature of an identifier of the current viewed content to obtain a first identifier feature, and determining a feature of an identifier of the candidate content to obtain a second identifier feature; concatenating the first identifier feature and the second identifier feature, to obtain a concatenated identifier feature corresponding to the candidate content; and predicting the recommendation score of the candidate content based on the comprehensive feature corresponding to the candidate content and the concatenated identifier feature corresponding to the candidate content.

Specifically, the server may determine a feature of the identifier of the user, to obtain a third identifier feature, and concatenate the first identifier feature, the second identifier feature, and the third identifier feature, to obtain a concatenated identifier feature corresponding to the candidate content. The first identifier feature, the second identifier feature, and the third identifier feature may be obtained by the server through encoding, or may be generated in advance.

In some embodiments, the recommendation score is obtained based on a recommendation score prediction network, the recommendation score prediction network may include an identifier encoding network, and the identifier encoding network is configured for encoding an identifier to obtain an identifier feature. The first identifier feature, the second identifier feature, and the third identifier feature may all be generated through the identifier encoding network.

In some embodiments, the server may further perform feature extraction on the concatenated identifier feature corresponding to the candidate content, to obtain an extracted identifier feature corresponding to the candidate content. The server may predict the recommendation score of the candidate content based on the comprehensive feature corresponding to the candidate content and the extracted identifier feature corresponding to the candidate content.

In some embodiments, the concatenated identifier feature corresponding to the candidate content is generated based on the feature of the identifier of the current viewed content and the feature of the identifier of the candidate content, and then the recommendation score of the candidate content is predicted based on the comprehensive feature corresponding to the candidate content and the concatenated identifier feature corresponding to the candidate content. Through use of the concatenated identifier feature, impact of the current viewed content and the candidate content on the predicted recommendation score is enhanced, so that the predicted recommendation score meets a real-time requirement, thereby improving accuracy of the recommendation score.

In some embodiments, the recommendation score is obtained through the recommendation score prediction network. The recommendation score prediction network includes at least one feature extraction layer, metric prediction networks respectively corresponding to a plurality of preset metrics, and an identifier feature extraction network. The predicting the recommendation score of the candidate content based on the comprehensive feature corresponding to the candidate content and the concatenated identifier feature corresponding to the candidate content includes: inputting the comprehensive feature corresponding to the candidate content into the recommendation score prediction network for processing by the at least one feature extraction layer, to obtain a metric feature corresponding to each preset metric; inputting the concatenated identifier feature corresponding to the candidate content into the identifier feature extraction network, to obtain an extracted identifier feature; for each preset metric, inputting the metric feature corresponding to the preset metric and the extracted identifier feature into the metric prediction network corresponding to the preset metric, to obtain a predicted value of the preset metric; and determining the recommendation score of the candidate content based on the predicted values of the preset metrics.

The recommendation score prediction network is configured for predicting the values of the plurality of preset metrics of the content. The preset metric includes, but is not limited to, at least one of a click-through rate, a quantity of subsequent viewed contents, or subsequent viewing duration. The quantity of subsequent viewed contents is a quantity of contents related to the candidate content viewed by the user when the candidate content is pushed to the user. A video is used as an example. In this case, the quantity of subsequent viewed contents may be referred to as a quantity of subsequent consumed videos. The subsequent viewing duration refers to duration for which the user views the content related to the candidate content when the candidate content is pushed to the user. The recommendation score prediction network includes the at least one feature extraction layer. The plurality of preset metrics refers to at least two preset metrics. The recommendation score prediction network includes the metric prediction networks respectively corresponding to the preset metrics, and an output result of a metric prediction network corresponding to a preset metric represents a predicted value of the preset metric. The identifier feature extraction network is configured for further extracting the concatenated identifier feature corresponding to the candidate content.

Specifically, one preset metric is used as an example to describe a process of generating the predicted value. The metric prediction network may include a plurality of fully connected layers that are cascaded. The server may input a metric feature corresponding to a preset metric into a corresponding metric prediction network, each time obtaining an output result of one fully connected layer, fuse the output result and the extracted identifier feature, then input a fusion result into a next fully connected layer, and after obtaining an output result of a last fully connected layer, fuse the output result of the last fully connected layer and the extracted identifier feature, to obtain a predicted value of the preset metric, for example, may determine a value represented by a fusion result to obtain the predicted value of the preset metric. The fusion includes, but is not limited to, at least one of multiplication or addition, and may be, for example, a Hadamard product operation.

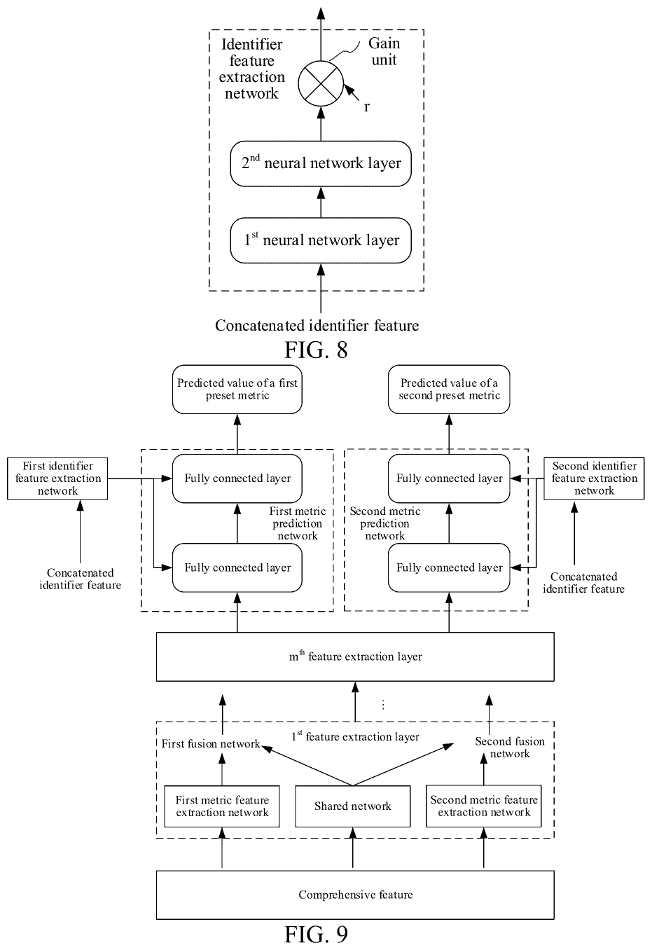

In some embodiments, the identifier feature extraction network is implemented by using a neural network. The identifier feature extraction network may include a plurality of neural network layers. Each neural network layer may be implemented by using a fully connected neural network or a convolutional neural network. The neural network layer may further include an activation function. Activation functions in the neural network layers may be the same or different. The activation function includes at least one of relu or sigmoid. The identifier feature extraction network may further include a gain unit, the gain unit has a gain coefficient, and the gain coefficient may be preset, or may be modified as required. An example in which the identifier feature extraction network includes two neural network layers is used. As shown in FIG. 8, a diagram of a structure of the identifier feature extraction network is shown. The identifier feature extraction network in FIG. 8 may be expressed as: x=RelU(input*W₁+b₁), RPₒᵤₜₚᵤₜ=r*sigmoid(x*W₂+b₂). A value range of RPₒᵤₜₚᵤₜ is [0, r], r is a gain coefficient, and may be preset to be, for example, 2, x is an output result of a 1^{st} neural network layer, input represents input data of the 1^{st} neural network layer, for example, the concatenated identifier feature, W₁ and b₁ are parameters of the 1^{st} neural network layer, RelU is an activation function of the 1^{st} neural network layer, W₂ and b₂ are parameters of a 2^{nd} neural network layer, sigmoid is an activation function of the 2^{nd} neural network layer, and RPₒᵤₜₚᵤₜ is an output result of the identifier feature extraction network, where both input and RPₒᵤₜₚᵤₜ are vectors or matrices, and dimensions of input and RPₒᵤₜₚᵤₜ are the same.

In some embodiments, the server may collect statistics on the predicted values of the preset metrics, to obtain the recommendation score of the candidate content. The recommendation score of the candidate content is in a positive correlation with the predicted value of each preset metric.

In some embodiments, the server may multiply the predicted values of the preset metrics, to obtain the recommendation score of the candidate content. For example, the server may multiply predicted values of a click-through rate, a quantity of subsequent consumed videos, and subsequent consumption duration, to obtain the recommendation score of the candidate content.

In some embodiments, the server may perform exponential multiplication on the predicted values of the preset metrics, to obtain the recommendation score of the candidate content. For example, the server may calculate the recommendation score of the candidate content by using a formula ranking_{score}=pclk^{t1}*pvv^{t2}*pdur^{t3}. ranking^{score} represents the recommendation score of the candidate content, pelk represents a predicted value of a click-through rate, pvv represents a predicted value of a quantity of subsequent viewed contents, and pdur represents a predicted value of subsequent viewing duration. t1, t2, and t3 are respectively exponents of pclk, pvv, and pdur, and t1, t2, and t3 may be set according to a requirement.

In some embodiments, the recommendation score prediction network predicts the predicted values of the plurality of preset metrics, so that the recommendation score of the candidate content is determined based on the predicted values of the preset metrics, thereby automatically generating the recommendation score, and improving efficiency of generating the recommendation score.

In some embodiments, each metric prediction network corresponds to at least one identifier feature extraction network. The inputting the concatenated identifier feature corresponding to the candidate content into the identifier feature extraction network, to obtain an extracted identifier feature includes: for each metric prediction network, inputting the concatenated identifier feature corresponding to the candidate content into the at least one identifier feature extraction network corresponding to the metric prediction network, to obtain the at least one extracted identifier feature respectively output by the at least one identifier feature extraction network corresponding to the metric prediction network; and the inputting the metric feature corresponding to the preset metric and the extracted identifier feature into the metric prediction network corresponding to the preset metric, to obtain a predicted value of the preset metric includes: inputting the metric feature corresponding to the preset metric and the at least one extracted identifier feature corresponding to the preset metric into the metric prediction network corresponding to the preset metric, to obtain the predicted value of the preset metric.

Identifier feature extraction networks respectively corresponding to the metric prediction networks may be the same or different. An example in which the recommendation score prediction network includes metric prediction networks respectively corresponding to two preset metrics, and each metric prediction network corresponds to one feature extraction network is used. As shown in FIG. 9, a diagram of a structure of the recommendation score prediction network is shown. In FIG. 9, the recommendation score prediction network includes m feature extraction layers, where m≥1, and includes two metric prediction networks, a first metric prediction network and a second metric prediction network, respectively. The first metric prediction network is a metric prediction network corresponding to a first preset metric, and the second metric prediction network is a metric prediction network corresponding to a second preset metric. A first identifier feature extraction network is an identifier feature extraction network corresponding to the first metric prediction network, and a second identifier feature extraction network is an identifier feature extraction network corresponding to the second metric prediction network.

Extracted identifier features corresponding to the preset metrics refer to extracted identifier features respectively output by identifier feature extraction networks corresponding to the metric prediction network of the preset metric.

Specifically, each metric prediction network includes a plurality of fully connected layers, and the fully connected layer adopts a fully connected neural network. The fully connected layers in the metric prediction network may be in one-to-one correspondence with the identifier feature extraction networks. Different metric prediction networks correspond to different identifier feature extraction networks. For example, if the first metric prediction network includes two fully connected layers, the two fully connected layers respectively correspond to different identifier feature extraction networks. One preset metric is used as an example to describe a process of generating the predicted value. The metric prediction network may include a plurality of fully connected layers that are cascaded. The server may input a metric feature corresponding to a preset metric into a corresponding metric prediction network, each time obtaining an output result of one fully connected layer, fuse the output result and an extracted identifier feature output by an identifier feature extraction network corresponding to the fully connected layer, then input a fusion result into a next fully connected layer, and after obtaining an output result of a last fully connected layer, fuse the output result of the last fully connected layer and an extracted identifier feature output by an identifier feature extraction network corresponding to the last fully connected layer, to obtain a predicted value of the preset metric, for example, may determine a value represented by a fusion result to obtain the predicted value of the preset metric. The fusion includes, but is not limited to, at least one of multiplication or addition, and may be, for example, a Hadamard product operation.

In some embodiments, a feature extraction layer in the recommendation score prediction network includes feature extraction networks respectively corresponding to the preset metrics. For example, in FIG. 9, a 1^{st} feature extraction network includes: a feature extraction network corresponding to the first preset metric, for example, a first metric feature extraction network, and a feature extraction network corresponding to the second preset metric, for example, a second metric feature extraction network. The feature extraction layer further includes a shared network and a fusion network corresponding to each feature extraction network. For example, in FIG. 9, the feature extraction layer includes a fusion network corresponding to the first metric feature extraction network, for example, a first fusion network, and a fusion network corresponding to the second metric feature extraction network, for example, a second fusion network. The fusion network is configured for fusing an output result of a corresponding feature extraction network and an output result of the shared network, where the fusion includes, but is not limited to, at least one of weighting, multiplication, or addition.

In some embodiments, the recommendation score prediction network may be a network obtained by optimizing a PLE structure, for example, adding an identifier feature extraction network based on the PLE structure. The feature extraction layer may be implemented by using an expert network layer (CGC, Customized Gate Control).

In some embodiments, because each metric prediction network corresponds to at least one identifier feature extraction network, an output result of the metric prediction network may be affected by using different extracted identifier features, thereby reducing an error, and improving accuracy of a predicted value.

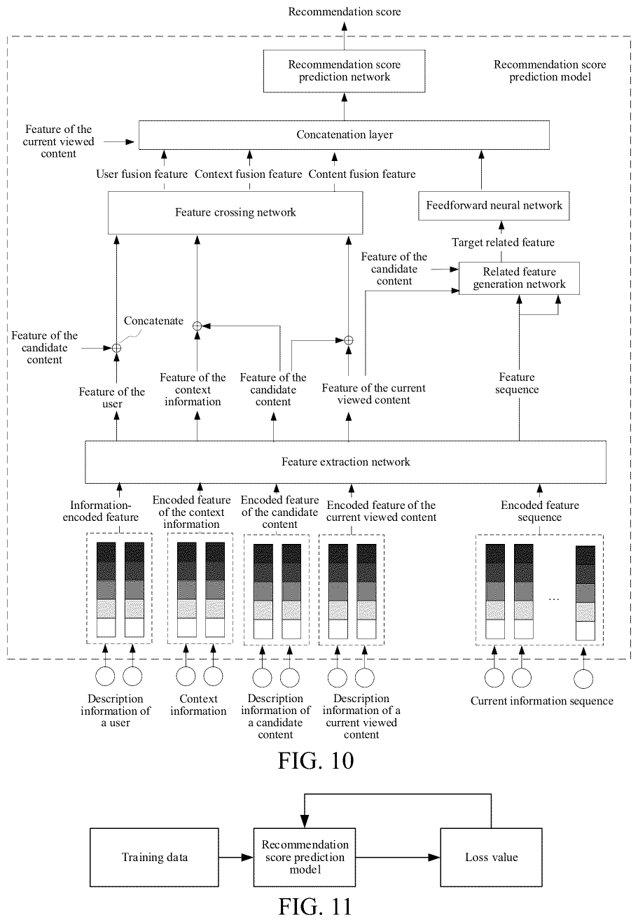

In some embodiments, the content pushing method provided in this application may be based on a recommendation score prediction model. As shown in FIG. 10, a diagram of a structure of the recommendation score prediction model is shown. A server inputs description information of a user, context information, description information of a candidate content, description information of a current viewed content, and a current information sequence into the recommendation score prediction model for encoding, to obtain an information-encoded feature, an encoded feature of the context information, an encoded feature of the candidate content, an encoded feature of the current viewed content, and an encoded feature sequence. The server inputs the information-encoded feature, the encoded feature of the context information, the encoded feature of the candidate content, the encoded feature of the current viewed content, and the encoded feature sequence into a feature extraction network, to generate a feature of the user, a feature of the context information, the encoded feature of the candidate content, and the encoded feature of the current viewed content, and a feature sequence. The server inputs the feature sequence, the encoded feature of the candidate content, and the encoded feature of the current viewed content into a related feature generation network of the current viewed content, to generate a related feature of a target current viewed content. The server concatenates the feature of the user and a feature of the candidate content and inputs a concatenated feature into a feature crossing network, to generate a user fusion feature; concatenates the feature of the context information and the encoded feature of the candidate content and inputs a concatenated feature into the feature crossing network, to generate a context fusion feature; and concatenates the encoded feature of the current viewed content and the encoded feature of the candidate content and inputs a concatenated feature into the feature crossing network, to generate a content fusion feature. The server inputs the related feature of the target current viewed content into a feedforward neural network to obtain an extracted target feature. The server inputs the extracted target feature, the encoded feature of the current viewed content, the user fusion feature, the context fusion feature, and the content fusion feature into a concatenation layer for concatenating, to obtain a comprehensive feature corresponding to the candidate content, inputs the comprehensive feature of the candidate content into a recommendation score prediction network, to predict predicted values of a plurality of preset metrics of the candidate content, and generates a recommendation score of the candidate content based on the predicted values. Descriptions of components in the recommendation score prediction model are described above, and details are not described herein again. Only the overall process of obtaining the recommendation value based on the recommendation score prediction model is described herein.

In some embodiments, as shown in FIG. 11, a diagram of a principle of training the recommendation score prediction model is shown. A process of training the recommendation score prediction model includes the following operations.

The server may determine a sample user from a plurality of users, obtain a content viewed by the sample user at a historical moment as a sample viewed content, obtain a content pushed to the sample user in real time when viewing of the sample viewed content is triggered, to obtain the pushed content, and obtain label values of the pushed content under a plurality of preset metrics, where the label value refers to a real value, for example, a real click-through rate, generated for the sample user for the pushed content. A historical information sequence corresponding to the sample user stored in the server at the historical moment may be further obtained, description information, context information, and the like of the sample user may be obtained, and training data is formed based on obtained data. During the training, the server may input the training data into the recommendation score prediction model, to obtain a predicted value corresponding to the pushed content. For a process of obtaining the predicted value of the pushed content, refer to the method of generating the predicted value of the candidate content in the use stage.

The server may determine label values of each pushed content under a plurality of preset metrics. For a preset metric, for example, a click-through rate, whose value is a discrete value, a loss value corresponding to the preset metric may be calculated by using a classification loss function and a label value. For a preset metric whose value is a continuous value, the server may calculate a difference between a predicted value of the preset metric and a label value of the preset metric, to obtain a loss value corresponding to the preset metric. The loss value corresponding to the preset metric is in a positive correlation with the difference. The server may update a parameter of the recommendation score prediction model based on loss values corresponding to the preset metrics, for example, may update the parameter by using a stochastic gradient descent method, and iteratively train the recommendation score prediction model until the recommendation score prediction model converges, to complete the training on the recommendation score training model.

When a value of a preset metric is a continuous value, a label value of the preset metric may be generated by using a generalized normalization manner. For example, if a value of subsequent viewing duration is continuous, generalized normalization may be performed on the actual value of the subsequent viewing duration to obtain a label value of the subsequent viewing duration. For example, a calculation formula is: The label value of the subsequent viewing duration=log₂((play_dur/quantity_value)+1). play_dur represents the actual value of the subsequent viewing duration, quantity_value is a preset value, and quantity_value may be, for example, any one of an average value or a median value of viewing duration of contents of a same type. Content types may be categorized as required. For example, video types may be categorized as TV series, programs for children, and the like.

Because the subsequent viewing duration has a causal relationship with clicking, for example, the user has long consumption behavior only when clicking first, when a predicted value of a click-through rate and a predicted value of the subsequent viewing duration are predicted, a new predicted value of the subsequent viewing duration may be generated based on the predicted value of the click-through rate and the predicted value of the subsequent viewing duration that are predicted, and a loss value corresponding to the subsequent viewing duration is generated based on a difference between the new predicted value and a label value of the subsequent viewing duration. For example, a formula loss_{duration}=loss(pclk*P_{duration}, label_{duration}) may be configured for calculating a loss value corresponding to subsequent viewing duration. loss_{duration} refers to the loss value corresponding to the subsequent viewing duration, pelk is a predicted value of a click-through rate, and P_{duration} is a predicted value of the subsequent viewing duration, and label_{duration} is a label value of the subsequent viewing duration.

In some embodiments, all or a part of networks in the trained recommendation score prediction model may be pre-trained first, and then the recommendation prediction score model as a whole is fine-tuned, to complete the training of the recommendation score prediction model. In some embodiments, the server may perform training in advance to obtain an information-encoded feature, an encoded feature of context information, an encoded feature of a content, and an encoded feature sequence. During the training of the recommendation score prediction model, the encoded features generated in advance are directly obtained for the training.

In some embodiments, the recommendation value of the candidate content is accurately predicted by using the recommendation score prediction model, thereby improving pushing accuracy.

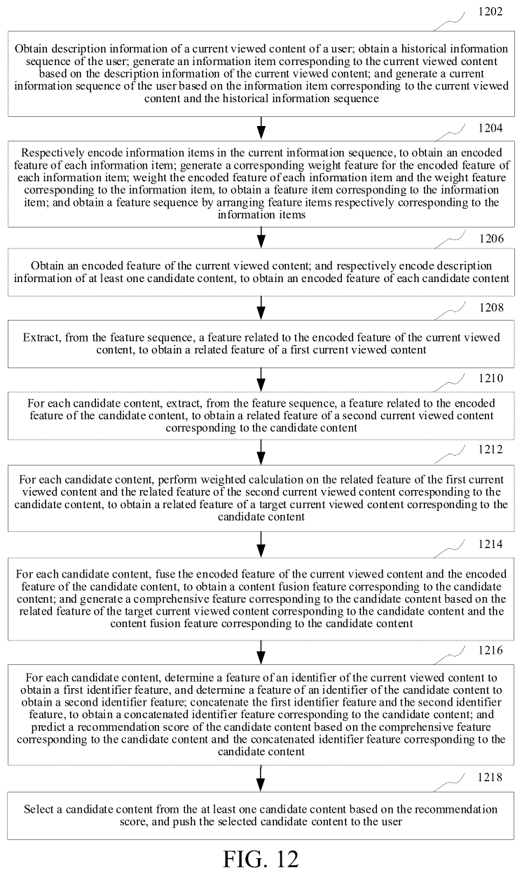

In some embodiments, as shown in FIG. 12, a content pushing method is provided. The method may be performed by a terminal or a server, or may be performed jointly by a terminal and a server. An example in which the method is applied to the server in FIG. 1 is used for description, and the method includes operation 1202 to operation 1218 below.

Operation 1202: Obtain description information of a current viewed content of a user; obtain a historical information sequence of the user; generate an information item corresponding to the current viewed content based on the description information of the current viewed content; and generate a current information sequence of the user based on the information item corresponding to the current viewed content and the historical information sequence.

The historical information sequence includes an information item corresponding to a historical viewed content of the user, and the information item corresponding to the historical viewed content includes description information of the historical viewed content.

Operation 1204: Respectively encode information items in the current information sequence, to obtain an encoded feature of each information item; generate a corresponding weight feature for the encoded feature of each information item; weight the encoded feature of each information item and the weight feature corresponding to the information item, to obtain a feature item corresponding to the information item; and obtain a feature sequence by arranging feature items respectively corresponding to the information items.

The feature sequence includes the feature items in one-to-one correspondence with the information items in the current information sequence.

Operation 1206: Obtain an encoded feature of the current viewed content; and respectively encode description information of at least one candidate content, to obtain an encoded feature of each candidate content.

The encoded feature of the current viewed content is obtained by encoding the description information of the current viewed content.

Operation 1208: Extract, from the feature sequence, a feature related to the encoded feature of the current viewed content, to obtain a related feature of a first current viewed content.

The server may perform first dimension-increasing processing on each feature item in the feature sequence, to obtain a first dimension-increased feature corresponding to the feature item, and perform second dimension-increasing processing on each feature item, to obtain a second dimension-increased feature corresponding to the feature item; perform third dimension-increasing processing on the encoded feature of the current viewed content, to obtain a third dimension-increased feature; and combine the first dimension-increased feature corresponding to each feature item and the third dimension-increased feature, to obtain a combined feature corresponding to the feature item. The server may fuse the second dimension-increased feature and the combined feature that correspond to each feature item, to obtain a related item corresponding to the feature item, and generate the related feature of the current viewed content based on the related items respectively corresponding to the feature items.

Operation 1210: For each candidate content, extract, from the feature sequence, a feature related to the encoded feature of the candidate content, to obtain a related feature of a second current viewed content corresponding to the candidate content.

Operation 1212: For each candidate content, perform weighted calculation on the related feature of the first current viewed content and the related feature of the second current viewed content corresponding to the candidate content, to obtain a related feature of a target current viewed content corresponding to the candidate content.

The server may further determine a weighting weight of the related feature of the first current viewed content, to obtain a first weighting weight, determine a weighting weight of the related feature of the second current viewed content corresponding to the candidate content, to obtain a second weighting weight, and perform weighted calculation on the related feature of the first current viewed content and the related feature of the second current viewed content by using the first weighting weight and the second weighting weight, to obtain the related feature of the target current viewed content corresponding to the candidate content.

Operation 1214: For each candidate content, fuse the encoded feature of the current viewed content and the encoded feature of the candidate content, to obtain a content fusion feature corresponding to the candidate content; and generate a comprehensive feature corresponding to the candidate content based on the related feature of the target current viewed content corresponding to the candidate content and the content fusion feature corresponding to the candidate content.

Operation 1216: For each candidate content, determine a feature of an identifier of the current viewed content to obtain a first identifier feature, and determine a feature of an identifier of the candidate content to obtain a second identifier feature; concatenate the first identifier feature and the second identifier feature, to obtain a concatenated identifier feature corresponding to the candidate content; and predict a recommendation score of the candidate content based on the comprehensive feature corresponding to the candidate content and the concatenated identifier feature corresponding to the candidate content.

Operation 1218: Select a candidate content from the at least one candidate content based on the recommendation score, and push the selected candidate content to the user.

In some embodiments, the current information sequence includes the information items respectively corresponding to a plurality of viewed contents of the user, the information item includes description information of a corresponding viewed content, and the plurality of viewed contents include the current viewed content and the historical viewed content. Because the current viewed content reflects a real-time interest of the user, the current information sequence includes information that can reflect the real-time interest of the user, thereby improving real-time pushing accuracy. Moreover, the feature related to the encoded feature of the current viewed content is extracted from the feature sequence, to obtain the related feature of the current viewed content. Because the related feature of the current viewed content is strongly related to the current viewed content, selecting the candidate content from the at least one candidate content based on the encoded feature of each candidate content and the related feature of the current viewed content, and pushing the selected candidate content to the user enhance impact of the current viewed content on content pushing, thereby making pushing better meet a real-time requirement, and improving accuracy of real-time pushing. The content pushing method provided in this application effectively resolves problems of insufficient relevance and inadequate description of a historical interest and a real-time interest in a recommendation scenario, and improves accuracy of real-time pushing.

The content pushing method provided in this application is applicable to a recommendation system of any media platform, and is configured for pushing a content on the media platform. A video platform is used as an example. When determining that a user triggers a playback operation for any video on the video platform, a server corresponding to the video platform determines a video corresponding to the playback operation, to obtain the current played video. The current played video is the foregoing current viewed content. The server obtains description information of the current played video and obtains a historical information sequence of the user. The historical information sequence includes an information item corresponding to a historical played video of the user, and information corresponding to the historical played video includes description information of the historical played video. The server generates an information item corresponding to the current played video based on the description information of the current played video, and generates a current information sequence of the user based on the information item corresponding to the current played video and the historical information sequence. The server encodes the current information sequence into a feature sequence. The feature sequence includes feature items in one-to-one correspondence with information items in the current information sequence. The server obtains a feature of the current played video, and extracts, from the feature sequence, a feature related to the feature of the current played video, to obtain a related feature of the current viewed content. The server encodes description information of at least one candidate video, to obtain a feature of each candidate video. For each candidate video, the server predicts a recommendation score of the candidate video based on the feature of the candidate video and the related feature of the current viewed content, selects a candidate video from the at least one candidate video based on the recommendation score, and pushes the selected candidate video to the user. The content pushing method provided in this application is applied to video pushing, which better meets a real-time requirement, and can improve accuracy of real-time video pushing.

An experiment is performed in a long video scenario, to obtain advantages of the content pushing method provided in this application, as shown in Table 1.

TABLE 1

| Long video detail | Offline | Online experiment | Relevance |
|---|---|---|---|
| page metric | AUC | metric | metric |
| Compared with | +0.003 | Average viewing | A matching score |
| a baseline | | duration + 1.2% | is increased by 5% |
| | | Average VV + | |
| | | 1.7% CTR + 1.97% | |

VV (VisitView) refers to a quantity of subsequent consumed videos, and may also be understood as a quantity of accesses of the user. CTR refers to a click-through rate (Click-Through-Rate). An AUC (Area Under Curve) is an area enclosed by an ROC (Receiver Operating Characteristic Curve) and coordinate axes, and is a model evaluation metric.

Although all the operations in the flowcharts of the embodiments are displayed sequentially as indicated by the arrows, the operations are not necessarily executed sequentially as indicated by the arrows. Unless otherwise explicitly specified in this specification, execution of the operations is not strictly limited in order, and the operations may be executed in other order. Moreover, at least a part of the operations in the flowcharts of the embodiments may include a plurality of operations or a plurality of stages. The operations or stages are not necessarily executed completely at the same moment and may be executed at different moments. The operations or stages are not necessarily sequentially executed, and may be executed alternately with other operations or at least a part of operations or stages of other operations.

Based on the same inventive concept, some embodiments of this application further provides a content pushing apparatus configured to implement the foregoing content pushing method. The implementation solution for resolving the problems provided by the apparatus is similar to that described in the foregoing method.

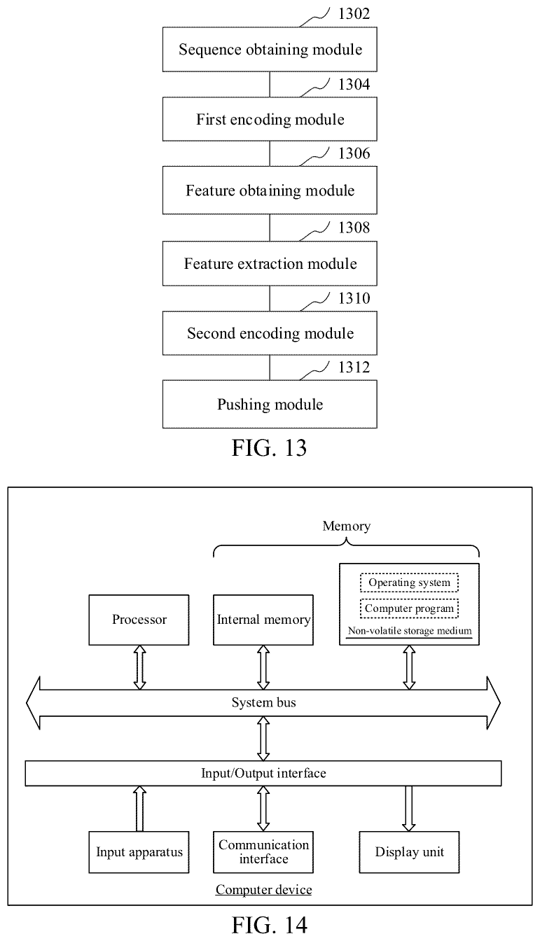

In some embodiments, as shown in FIG. 13, a content pushing apparatus is provided, including: a sequence obtaining module 1302, a first encoding module 1304, a feature obtaining module 1306, a feature extraction module 1308, a second encoding module 1310, and a pushing module 1312.

The sequence obtaining module 1302 is configured to obtain a current information sequence of a user, the current information sequence including a plurality of information items, each information item corresponding to one viewed content of the user, the plurality of information items including an information item corresponding to a current viewed content and an information item corresponding to at least one historical viewed content, and the information items in the current information sequence being arranged in a viewing order of viewed contents corresponding to the information items.

The first encoding module 1304 is configured to encode the current information sequence into a feature sequence, the feature sequence including feature items in one-to-one correspondence with the information items in the current information sequence, each feature item representing an encoded feature obtained by encoding an information item corresponding to the feature item.

The feature obtaining module 1306 is configured to obtain an encoded feature of the current viewed content, the encoded feature of the current viewed content being obtained by encoding description information of the current viewed content.

The feature extraction module 1308 is configured to extract, from the feature sequence, a feature related to the encoded feature of the current viewed content, to obtain a related feature of the current viewed content.

The second encoding module 1310 is configured to obtain description information of at least one candidate content, and respectively encode the description information of the at least one candidate content, to obtain an encoded feature of each candidate content.

The pushing module 1312 is configured to select a candidate content from the at least one candidate content based on the encoded feature of each candidate content and the related feature of the current viewed content, and push the selected candidate content to the user.

Based on the content pushing apparatus provided in this application, the current information sequence includes the information items respectively corresponding to the plurality of viewed contents of the user, the information item includes description information of a corresponding viewed content, and the plurality of viewed contents include the current viewed content and the historical viewed content. Because the current viewed content reflects a real-time interest of the user, the current information sequence includes information that can reflect the real-time interest of the user, thereby improving real-time pushing accuracy. Moreover, the feature related to the encoded feature of the current viewed content is extracted from the feature sequence, to obtain the related feature of the current viewed content. Because the related feature of the current viewed content is strongly related to the current viewed content, selecting the candidate content from the at least one candidate content based on the encoded feature of each candidate content and the related feature of the current viewed content, and pushing the selected candidate content to the user enhance impact of the current viewed content on content pushing, thereby making pushing better meet a real-time requirement, and improving accuracy of real-time pushing.

In some embodiments, the sequence obtaining module 1302 is further configured to: obtain: obtain the description information of the current viewed content of the user; obtain a historical information sequence of the user, the historical information sequence including the information item corresponding to the at least one historical viewed content of the user, the information item corresponding to the historical viewed content including description information of the historical viewed content; generate the information item corresponding to the current viewed content based on the description information of the current viewed content; and generate the current information sequence of the user based on the information item corresponding to the current viewed content and the historical information sequence.

In some embodiments, the feature extraction module 1308 is further configured to combine each feature item in the feature sequence with the encoded feature of the current viewed content, to obtain a combined feature corresponding to the feature item; fuse each feature item and the combined feature corresponding to the feature item, to obtain a related item corresponding to the feature item; and generate the related feature of the current viewed content based on the related items respectively corresponding to the feature items.

In some embodiments, the feature extraction module 1308 is further configured to: perform first dimension-increasing processing on each feature item in the feature sequence, to obtain a first dimension-increased feature corresponding to the feature item, and perform second dimension-increasing processing on each feature item, to obtain a second dimension-increased feature corresponding to the feature item; perform third dimension-increasing processing on the encoded feature of the current viewed content, to obtain a third dimension-increased feature; combine the first dimension-increased feature corresponding to each feature item and the third dimension-increased feature, to obtain the combined feature corresponding to the feature item; fuse the second dimension-increased feature and the combined feature that correspond to each feature item, to obtain a feature of the feature item related to the encoded feature of the current viewed content, and obtain the related item corresponding to the feature item; and generate the related feature of the current viewed content based on the related items respectively corresponding to the feature items.

In some embodiments, In some embodiments, the feature extraction module 1308 is further configured to: fuse the first dimension-increased feature corresponding to each feature item and the third dimension-increased feature, to obtain a dimension-increased fusion feature corresponding to the feature item; and for each feature item, concatenate the dimension-increased fusion feature corresponding to the feature item, the first dimension-increased feature corresponding to the feature item, and the third dimension-increased feature, to obtain the combined feature corresponding to the feature item.

In some embodiments, the first encoding module 1304 is further configured to: respectively encode the information items in the current information sequence, to obtain an encoded feature of each information item; generate a corresponding weight feature for the encoded feature of each information item; weight the encoded feature of each information item and the weight feature corresponding to the information item, to obtain a feature item corresponding to the information item; and obtain the feature sequence by arranging the feature items respectively corresponding to the information items.

In some embodiments, the pushing module 1312 is further configured to: for each candidate content, generate a comprehensive feature corresponding to the candidate content based on the encoded feature of the candidate content and the related feature of the current viewed content; and predict a recommendation score of each candidate content based on the comprehensive feature corresponding to the candidate content; and select the candidate content from the at least one candidate content based on the recommendation score, and push the selected candidate content to the user.

In some embodiments, the related feature of the current viewed content is a related feature of a first current viewed content. The pushing module 1312 is further configured to: extract, from the feature sequence, a feature related to the encoded feature of the candidate content, to obtain a related feature of a second current viewed content corresponding to the candidate content; and generate the comprehensive feature corresponding to the candidate content based on the related feature of the first current viewed content and the related feature of the second current viewed content corresponding to the candidate content.

In some embodiments, the pushing module 1312 is further configured to: fuse the encoded feature of the current viewed content and the encoded feature of the candidate content, to obtain a content fusion feature corresponding to the candidate content; and generate the comprehensive feature corresponding to the candidate content based on the content fusion feature corresponding to the candidate content and the related feature of the current viewed content.

In some embodiments, the pushing module 1312 is further configured to: for each candidate content, determine a feature of an identifier of the current viewed content to obtain a first identifier feature, and determine a feature of an identifier of the candidate content to obtain a second identifier feature; concatenate the first identifier feature and the second identifier feature, to obtain a concatenated identifier feature corresponding to the candidate content; and predict the recommendation score of the candidate content based on the comprehensive feature corresponding to the candidate content and the concatenated identifier feature corresponding to the candidate content.

In some embodiments, the recommendation score is obtained through a recommendation score prediction network. The recommendation score prediction network includes at least one feature extraction layer, metric prediction networks respectively corresponding to a plurality of preset metrics, and an identifier feature extraction network. The pushing module 1312 is further configured to: input the comprehensive feature corresponding to the candidate content into the recommendation score prediction network for processing by the at least one feature extraction layer, to obtain a metric feature corresponding to each preset metric; input the concatenated identifier feature corresponding to the candidate content into the identifier feature extraction network, to obtain an extracted identifier feature; for each preset metric, input the metric feature corresponding to the preset metric and the extracted identifier feature into the metric prediction network corresponding to the preset metric, to obtain a predicted value of the preset metric; and determine the recommendation score of the candidate content based on the predicted values of the preset metrics.

In some embodiments, each metric prediction network corresponds to at least one identifier feature extraction network. The pushing module 1312 is further configured to: for each metric prediction network, input the concatenated identifier feature corresponding to the candidate content into the at least one identifier feature extraction network corresponding to the metric prediction network, to obtain the at least one extracted identifier feature respectively output by the at least one identifier feature extraction network corresponding to the metric prediction network; and input the metric feature corresponding to the preset metric and the at least one extracted identifier feature corresponding to the preset metric into the metric prediction network corresponding to the preset metric, to obtain the predicted value of the preset metric.

The modules in the above content pushing apparatus may be implemented entirely or partly by software, hardware, or a combination thereof. The modules may be embedded in or independent of a processor in a computer device in the form of hardware, or may be stored in the memory of the computer device in the form of software, for the processor to invoke and execute operations corresponding to the modules.

In some embodiments, a computer device is provided. The computer device may be a server. An internal structure diagram of the computer device may be shown in FIG. 14. The computer device includes a processor, a memory, an input/output (I/O) interface, and a communication interface. The processor, the memory, and the I/O interface are connected through a system bus. The communication interface is connected to the system bus through the I/O interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for running of the operating system and the computer program in the non-volatile storage medium. The database of the computer device is configured to store data involved in the content pushing method provided in this application. The input/output interface of the computer device is configured to exchange information between the processor and an external device. The communication interface of the computer device is configured to connect to and communicate with an external terminal through a network. The computer program implements a content pushing method when being executed by the processor.

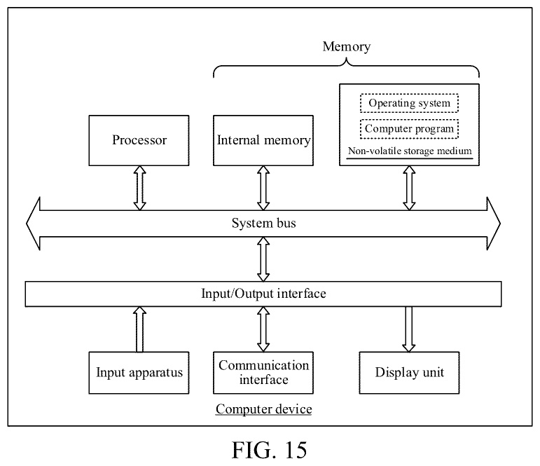

In some embodiments, a computer device is provided. The computer device may be a terminal. An internal structure diagram of the computer device may be shown in FIG. 15. The computer device includes a processor, a memory, an input/output interface, a communication interface, a display unit, and an input apparatus. The processor, the memory and the input/output interface are connected through a system bus. The communication interface, the display unit, and the input apparatus are connected to the system bus through the input/output interface. The processor of the computer device is configured to provide computing and control capabilities. The memory of the computer device includes a non-volatile storage medium and an internal memory. The non-volatile storage medium stores an operating system and a computer program. The internal memory provides an environment for running of the operating system and the computer program in the non-volatile storage medium. The input/output interface of the computer device is configured to exchange information between the processor and an external device. The communication interface of the computer device is configured to conduct wired or wireless communication with an external terminal. The wireless communication may be implemented through wireless fidelity (Wi-Fi), a mobile cellular network, near field communication (NFC), or another technology. The computer program, when executed by the processor, causes the processor to implement a content pushing method. The display unit of the computer device is configured to form a visually visible image, and may be a display screen, a projection apparatus, or a virtual reality imaging apparatus. The display screen may be a liquid crystal display screen or an electronic-ink display screen. The input apparatus of the computer device may be a touch layer covering the display screen, or may be a key, a trackball, or a touchpad arranged on a housing of the computer device, or may be an external keyboard, touchpad, mouse, etc.

A person skilled in the art may understand that, FIG. 14 and FIG. 15 are merely block diagrams of partial structures related to the solution of this application, and do not constitute a limitation to the computer device to which the solution of this application is applied. Specifically, the computer device may include more components or fewer components than those shown in the figure, or some components may be combined, or a different component arrangement may be used.

In some embodiments, a computer device is provided, including a memory and a processor, the memory having a computer program stored therein, and the processor implementing operations of the content pushing method when executing the computer program.

In some embodiments, a computer-readable storage medium is provided, having a computer program stored therein, the computer program implementing operations of the content pushing method when being executed by a processor.

In some embodiments, a computer program product is provided, including a computer program, the computer program implementing operations of the content pushing method when being executed by a processor.

User information (including, but not limited to, user equipment information, user personal information, and the like) and data (including, but not limited to, data for analysis, stored data, displayed data, and the like) involved in this application are information and data that are authorized by a user or fully authorized by all parties. Collection, use, and processing of related data may comply with relevant laws and regulations.

A person of ordinary skill in the art may understand that all or some of procedures of the method in the foregoing embodiments may be implemented by a computer program instructing relevant hardware. The program may be stored in a non-volatile computer-readable storage medium. When the program is executed, the procedures of the foregoing method embodiments may be implemented. Any reference to a memory, a database, or other media used in all the embodiments provided in this application may include at least one of a nonvolatile memory and a volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM), an external cache, etc. By way of description rather than limitation, the RAM may be in various forms, such as a static random access memory (SRAM) or a dynamic random access memory (DRAM). The database involved in the embodiments provided in this application may include at least one of a relational database and a non-relational database. The non-relational database may include a blockchain-based distributed database, but is not limited thereto. The processor involved in the embodiments provided in this application may be a general purpose processor, a central processing unit, a graphic processing unit, a digital signal processor, a programmable logic unit, a data processing logic unit based on quantum computing, and the like, but is not limited thereto.

The technical features of the foregoing embodiments may be arbitrarily combined to form new embodiments. For the sake of brevity of description, not all possible combinations of the technical features in the foregoing embodiments are described. However, where no contradiction exists, all the combinations of these technical features are contemplated in the scope of this specification.

The foregoing embodiments are merely illustrative of some embodiments, and the description of the foregoing embodiments is detailed, but is not to be construed as limiting the scope of this application. For a person of ordinary skill in the art, several variations and improvements can be made without departing from the concept of this application, and such variations and improvements all fall within the protection scope of this application. Therefore, the protection scope of this application shall be subject to the appended claims.

The technical features of the foregoing embodiments may be arbitrarily combined to form new embodiments. For the sake of brevity of description, not all possible combinations of the technical features in the foregoing embodiments are described. However, where no contradiction exists, all the combinations of these technical features are contemplated in the scope of this specification.

The foregoing embodiments are merely illustrative of some embodiments. For a person of ordinary skill in the art, several variations and improvements can be made without departing from the concept of this application, and such variations and improvements all fall within the protection scope of this application. Therefore, the protection scope of this application shall be subject to the appended claims.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A content pushing method, performed by a computer device and comprising:
obtaining a current information sequence of a user comprising a plurality of information items that are arranged in a viewing order, the plurality of information items comprising at least one information item corresponding to at least one current viewed content and at least one information item corresponding to at least one historical viewed content, encoding the current information sequence into a feature sequence, the feature sequence comprising feature items corresponding with the information items, each of the feature items representing an encoded feature;
obtaining and encoding description information of the at least one current viewed content to obtain an encoded feature of the at least one current viewed content;
extracting, from the feature sequence, a feature related to the encoded feature of the current viewed content, to obtain a related feature of the current viewed content;
obtaining and encoding description information of at least one candidate content to obtain an encoded feature of each of the at least one candidate content;
selecting a candidate content from the at least one candidate content based on the encoded feature of each of the at least one candidate content and the related feature of the current viewed content; and
pushing the selected candidate content to the user.

2. The method according to claim 1, wherein the obtaining a current information sequence of a user comprises:
obtaining the description information of the at least one current viewed content of the user;
obtaining a historical information sequence of the user, the historical information sequence comprising the at least one information item corresponding to the at least one historical viewed content of the user, wherein each of the at least one information item comprises description information of a corresponding historical viewed content;
generating at least one information item corresponding to the at least one current viewed content based on the description information of the at least one current viewed content; and
generating the current information sequence of the user based on the information item corresponding to the at least one current viewed content and the historical information sequence.

3. The method according to claim 1, wherein the extracting comprises:
combining each of the feature items in the feature sequence with the encoded feature of the at least one current viewed content, to obtain a combined feature corresponding to the each of the feature items;
fusing each of the feature items and the combined feature to obtain a related item corresponding to the each of the feature items; and
generating the related feature of the at least one current viewed content based on the related items corresponding to the feature items.

4. The method according to claim 3,
wherein the combining comprises:
performing first dimension-increasing processing on each of the feature items in the feature sequence, to obtain a first dimension-increased feature;
performing second dimension-increasing processing on each of the feature items, to obtain a second dimension-increased feature;
performing third dimension-increasing processing on the encoded feature of the at least one current viewed content, to obtain a third dimension-increased feature; and
combining the first dimension-increased feature and the third dimension-increased feature, to obtain the combined feature corresponding to the each of the feature items; and
wherein the fusing comprises:
fusing the second dimension-increased feature and the combined feature to obtain the related item.

5. The method according to claim 4, wherein the combining comprises:
fusing the first dimension-increased feature and the third dimension-increased feature, to obtain a dimension-increased fusion feature corresponding to the feature item; and
concatenating the dimension-increased fusion feature, the first dimension-increased feature, and the third dimension-increased feature, to obtain the combined feature for each of the feature items.

6. The method according to claim 1, wherein the encoding the current information sequence into the feature sequence comprises:
encoding each of the plurality of information items in the current information sequence, to obtain an encoded feature;
generating a weight feature corresponding to the encoded feature;
weighting the encoded feature and the weight feature to obtain the feature item corresponding to each of the plurality of information items; and
arranging the feature items corresponding to the plurality of information items to obtain the feature sequence.

7. The method according to claim 1, wherein the selecting comprises:
generating a comprehensive feature corresponding to the at least one candidate content based on the encoded feature of the at least one candidate content and the related feature of the at least one current viewed content;
predicting a recommendation score of each of the at least one candidate content based on the comprehensive feature; and
selecting the candidate content from the at least one candidate content based on the recommendation score; and
pushing the selected candidate content to the user.

8. The method according to claim 7, wherein the related feature of the at least one current viewed content is a related feature of a first current viewed content, and
wherein the generating a comprehensive feature comprises:
extracting, from the feature sequence, a feature related to the encoded feature of the at least one candidate content, to obtain a related feature of a second current viewed content; and
generating the comprehensive feature corresponding to the at least one candidate content based on the related feature of the first current viewed content and the related feature of the second current viewed content.

9. The method according to claim 7, wherein the generating a comprehensive feature comprises:
fusing the encoded feature of the at least one current viewed content and the encoded feature of the at least one candidate content, to obtain a content fusion feature; and
generating the comprehensive feature corresponding to the candidate content based on the content fusion feature corresponding to the at least one candidate content and the related feature of the at least one current viewed content.

10. The method according to claim 7, wherein the predicting a recommendation score comprises:
determining, for each of the at least one candidate content, a first identifier feature of an identifier of the at least one current viewed content and a second identifier feature of an identifier of the at least one candidate content;
concatenating the first identifier feature and the second identifier feature, to obtain a concatenated identifier feature; and
predicting the recommendation score of the candidate content based on the comprehensive feature and the concatenated identifier feature corresponding to the at least one candidate content.

11. The method according to claim 10,
wherein the recommendation score is obtained based on a recommendation score prediction network, the recommendation score prediction network comprising at least one feature extraction layer, metric prediction networks corresponding to a plurality of preset metrics, and an identifier feature extraction network; and
wherein the predicting comprises:
inputting the comprehensive feature corresponding to the at least one candidate content into the recommendation score prediction network;
obtaining, based on the at least one feature extraction layer, a metric feature corresponding to each of the plurality of preset metrics;
inputting the concatenated identifier feature corresponding to the candidate content into the identifier feature extraction network, to obtain an extracted identifier feature;
inputting, for each of the plurality of preset metrics, the metric feature and the extracted identifier feature into the metric prediction network, to obtain a predicted value; and
determining the recommendation score of the candidate content based on the predicted values of the plurality of preset metrics.

12. A content pushing apparatus, comprising:
at least one memory configured to store program code; and
at least one processor configured to read the program code and operate as instructed by the program code, the program code comprising:
obtaining code configured to cause at least one of the at least one processor to obtain a current information sequence of a user comprising a plurality of information items that are arranged in a viewing order, the plurality of information items comprising at least one information item corresponding to at least one current viewed content and at least one information item corresponding to at least one historical viewed content;
encoding code configured to cause at least one of the at least one processor to encode the current information sequence into a feature sequence, the feature sequence comprising feature items corresponding with the information items, each of the feature items representing an encoded feature;
description code configured to cause at least one of the at least one processor to obtain and encode description information of the at least one current viewed content to obtain an encoded feature of the at least one current viewed content;
extracting code configured to cause at least one of the at least one processor to extract, from the feature sequence, a feature related to the encoded feature of the current viewed content, to obtain a related feature of the current viewed content;
candidate code configured to cause at least one of the at least one processor to obtain and encode description information of at least one candidate content to obtain an encoded feature of each of the at least one candidate content;
selecting code configured to cause at least one of the at least one processor to select a candidate content from the at least one candidate content based on the encoded feature of each of the at least one candidate content and the related feature of the current viewed content; and
pushing code configured to cause at least one of the at least one processor to push the selected candidate content to the user.

13. The apparatus according to claim 12, wherein the obtaining code is further configured to cause at least one of the at least one processor to:
obtain the description information of the at least one current viewed content of the user;
obtain a historical information sequence of the user, the historical information sequence comprising the at least one information item corresponding to the at least one historical viewed content of the user, wherein each of the at least one information item comprises description information of a corresponding historical viewed content;
generate at least one information item corresponding to the at least one current viewed content based on the description information of the at least one current viewed content; and
generate the current information sequence of the user based on the information item corresponding to the at least one current viewed content and the historical information sequence.

14. The apparatus according to claim 12, wherein the extracting code is further configured to cause at least one of the at least one processor to:
combine each of the feature items in the feature sequence with the encoded feature of the at least one current viewed content, to obtain a combined feature corresponding to the each of the feature items;
fuse each of the feature items and the combined feature to obtain a related item corresponding to the each of the feature items; and
generate the related feature of the at least one current viewed content based on the related items corresponding to the feature items.

15. The apparatus according to claim 14,
wherein the extracting code is further configured to cause at least one of the at least one processor to:
perform first dimension-increasing processing on each of the feature items in the feature sequence, to obtain a first dimension-increased feature;
perform second dimension-increasing processing on each of the feature items, to obtain a second dimension-increased feature;
perform third dimension-increasing processing on the encoded feature of the at least one current viewed content, to obtain a third dimension-increased feature; and
combine the first dimension-increased feature and the third dimension-increased feature, to obtain the combined feature corresponding to the each of the feature items; and
fuse the second dimension-increased feature and the combined feature to obtain the related item.

16. The apparatus according to claim 15, wherein the extracting code is further configured to cause at least one of the at least one processor to:
fuse the first dimension-increased feature and the third dimension-increased feature, to obtain a dimension-increased fusion feature corresponding to the feature item; and
concatenate the dimension-increased fusion feature, the first dimension-increased feature, and the third dimension-increased feature, to obtain the combined feature for each of the feature items.

17. The apparatus according to claim 12, wherein the encoding code is further configured to cause at least one of the at least one processor to:
encode each of the plurality of information items in the current information sequence, to obtain an encoded feature;
generate a weight feature corresponding to the encoded feature;
weight the encoded feature and the weight feature to obtain the feature item corresponding to each of the plurality of information items; and
arrange the feature items corresponding to the plurality of information items to obtain the feature sequence.

18. The apparatus according to claim 12, wherein the selecting code is further configured to cause at least one of the at least one processor to:
generate a comprehensive feature corresponding to the at least one candidate content based on the encoded feature of the at least one candidate content and the related feature of the at least one current viewed content;
predict a recommendation score of each of the at least one candidate content based on the comprehensive feature; and
select the candidate content from the at least one candidate content based on the recommendation score; and
wherein the pushing code is further configured to cause at least one of the at least one processor to push the selected candidate content to the user.

19. The apparatus according to claim 18,
wherein the related feature of the at least one current viewed content is a related feature of a first current viewed content, and
wherein the selecting code is further configured to cause at least one of the at least one processor to:
extract, from the feature sequence, a feature related to the encoded feature of the at least one candidate content, to obtain a related feature of a second current viewed content; and
generate the comprehensive feature corresponding to the at least one candidate content based on the related feature of the first current viewed content and the related feature of the second current viewed content.

20. A non-transitory computer-readable storage medium, storing computer code which, when executed by at least one processor, causes the at least one processor to at least:
obtain a current information sequence of a user comprising a plurality of information items that are arranged in a viewing order, the plurality of information items comprising at least one information item corresponding to at least one current viewed content and at least one information item corresponding to at least one historical viewed content;
encode the current information sequence into a feature sequence, the feature sequence comprising feature items corresponding with the information items, each of the feature items representing an encoded feature;
obtain and encode description information of the at least one current viewed content to obtain an encoded feature of the at least one current viewed content;
extract, from the feature sequence, a feature related to the encoded feature of the current viewed content, to obtain a related feature of the current viewed content;
obtain and encode description information of at least one candidate content to obtain an encoded feature of each of the at least one candidate content;
select a candidate content from the at least one candidate content based on the encoded feature of each of the at least one candidate content and the related feature of the current viewed content; and
push the selected candidate content to the user.
